(19) United States
(12) Patent Application Publication
(10) Pub. No.: US 2024/0092991 A1
(43) Pub. Date: Mar. 21, 2024

(54) MODULAR TEXTILE RECYCLING SYSTEM AND PROCESS

(71) Applicant: Regenerated Textile Industries, LLC, Seattle, WA (US)

(72) Inventors: Zahlen Titcomb, Seattle, WA (US); Ashley Holding, Elz (DE)

(21) Appl. No.: 18/038,542

(22) PCT Filed: Nov. 24, 2021
(86) PCT No.: PCT/US2021/060819

§ 371 Date: May 24, 2023

Related U.S. Application Data
(60) Provisional application No. 63/118,566, filed on Nov. 25, 2020.

(51) Int. Cl. C08J 11/08; B29B 17/02; C08B 16/00; D01F 2/00; D01F 6/62

(52) U.S. Cl. CPC C08J 11/08; B29B 17/02; C08B 16/00; D01F 2/00; D01F 6/62; B29B 2017/0203; B29B 2017/0293; B29B 2017/0476; C08J 2301/02; C08J 2367/02; C08J 2475/04

(57) ABSTRACT

A modular system and process are described for recycling textile waste of various compositions into new ready to use fibers for garment manufacturing or other uses.

### CROSS-REFERENCE TO RELATED APPLICATION(S)

This application claims priority to U.S. Provisional Application No. 63/118,566 filed Nov. 25, 2020, which is incorporated herein by reference, in its entirety, for any purpose.

### FIELD

The present disclosure relates generally to textile recycling processes, such as solvent purification processes and cellulose recycling processes, which may be used independently or applied in a modular textile recycling system for recycling textiles, including but not limited to post-consumer and post-industrial textiles, into new ready to use fibers for garment manufacturing or other uses.

### BACKGROUND

Textile waste is a significant waste stream that is currently difficult to abate, and a large percentage of both pre-consumer and post-consumer textile waste (including garments, as well as other sources such as homeware or hospitality) currently enters landfill or incineration. Textile recycling currently requires collection and transporting of post-consumer and post-industrial textiles to a specialized facility that can recycle these materials for re-use into new fibers and textiles. However, collecting, sorting, and transporting post-consumer and post-industrial textiles to the appropriate centralized recycling facility introduces significant cost into the recycling process, reducing the incentive for businesses and consumers to recycle textiles and thus creating textile waste. There are many challenges in the recycling of textiles, but a key roadblock is the presence of contaminating polymers such as elastane (polyurethane elastomers).

Elastane (also known as ‘spandex’ and known under trade names such as ‘Lycra’) is present in a large amount in textiles both synthetic (polyester, nylon) and natural (cotton, rayon), and typically presents problems with recycling processes. In large amounts, elastane may hinder extrusion with melt based ‘mechanical’ recycling and affect the properties of the resulting fibre. Elastane, as a polyurethane, is also susceptible to similar glycolysis and hydrolysis reactions used in so called ‘chemical’ recycling of polyethylene terephthalate (PET) and polyamides, and thus can contaminate the monomer products of these processes with unwanted side products. The presence of dyes is also a hindrance, as it means that either non-specific coloured products or only specific single-coloured products can be produced, necessitating pre-sorting by colour. There are also a wide range of both organic and inorganic potential additives and coatings that could interfere with potential mechanical or chemical recycling techniques. Finally, other synthetic textile fibres such as acrylic can be present in small amounts, especially in blends with other synthetics or natural fibres such as wool, which can also present problems.

Some processes for the removal of elastane from both synthetic textile materials have been developed. In WO2013032408A1 elastane fibres are removed from polyamide textiles through a controlled thermal degradation process in an inert atmosphere, followed by washing with a polar solvent, such as ethanol, followed by subsequent purification of the solvent. WO2020130825A1 demonstrates the removal of polyurethane fibres from cellulose-based textiles, where the cellulose-based textile is subjected to combination of amines, a polar solvent such as DMF, and glycol and heat in order to remove the polyurethane by a degradative mechanism, which may be undesirable. In U.S. Ser. No. 11/085,14862, dyes are removed from textiles using a hydrothermal process combined with a sorbent material, in a pressurised reactor. In U.S. Ser. No. 11/001,96162, an oxidative method with peroxide, iron water and acetone mixtures are used to decolour polyester textiles. These existing processes may have various shortcomings still unaddressed by the state of the art.

Cellulose recycling processes may also benefit from further improvement. One approach for the separation of polyester from cotton involves the dissolution of the polyester, as described in U.S. Pat. No. 5,342,854, WO2014045062A1 (Walker et. al), and US20210079564A1 (Klaus-Nietrost et. al.). An alternative approach is to turn the cellulose in the blend into a cellulose derivative, which is more easily dissolvable, and then using it to make cellulose-derivative products. U.S. Pat. No. 3,937,671, WO2020013755A1 (Brelid et. al.), and WO2019140245A1 (Berle et. al.) describe such examples. Another approach is to degrade the polyester component in the blended textiles to its monomer building blocks by a chemical process such as hydrolysis, glycolysis, alcoholysis, or aminolysis; thus liberating the remaining cellulose component. A further approach is to degrade the cellulosic component such that the polyester is liberated from the blend, as described in CN109467741A. As can be seen there remains a need for additional solutions to cellulose recycling, and more generally to textile recycling and associated processes, and industry, therefore, continues to seek improvements thereto.

### SUMMARY

A modular textile recycling system is described, as well as various processes for textile recycling including a method for purifying a desired target polymer or polymers in a blended textile or mixture of textiles, via dissolution of an undesired minority polymer and other soluble contaminants, to provide a purified desired target polymer(s) for downstream recycling via various methods. In accordance with the present disclosure, described herein is a method of preparing waste textiles, both synthetic and natural, for recycling that removes contaminating polymers and other substances, such as dyes and various coatings or additives. This can be, for example, polyester and elastane blends, cotton and elastane blends, nylon and elastane blends, polycotton and elastane blends, or other mixtures including polymers such as acrylic, where one or more specific materials or polymers are the intended ‘target’ for further downstream recycling.

A purification method according to some embodiments aims to minimise degradation and yield loss of the targeted polymer in textile waste, by minimising interaction between the solvent and the targeted polymers for downstream recycling and keeping conditions as mild as possible. To that end, the process utilizes a set of solvents that dissolves elastane and/or other impurities, whilst having a low a boiling point as possible, lower than the melting point of synthetic fibres (i.e. PET), such that the targeted polymer is not readily dissolvable in the solvent, being selective for only the unwanted polymers and contaminants. This forms a departure from solvent-based recycling processes where the targeted polymer is usually dissolved and regenerated, often under harsh conditions including high temperatures, pressures, or vacuums. In contrast, in accordance with the present disclosure, only the unwanted polymers and contaminants, including dyes, are dissolved, under mild conditions, leaving the targeted polymers in the textile undisturbed for further processing, for example, by melt extrusion, after removal of the residual solvent on the textile. As such this process can also be referred to as a “purification” process for the target polymer in the textiles prior to recycling, which avoids the need for more energy intensive “chemical” recycling, such as depolymerisation. An additional advantage may be provided in that both dyes and unwanted polymers, such as elastane, can be removed in the same, single step, with only one kind of chemical required, where previously two separate processes would have been needed, and/or more complex mixtures of chemicals. The process can also be applied to mixtures of natural fibres such as cotton mixed with elastane, or wool mixed with acrylic, or even polycotton blends, in order to prepare them for downstream mechanical recycling (i.e. opening, carding and yarn spinning) or to prepare cotton as a feedstock for man-made cellulosic fibre (rayon) production, or other alternative recycling methods.

Described also are processes for the separation of polyester and cotton, in which both the cellulose and polyester components of the waste stream (e.g., the textile waste feedstock) would be preserved, and not degraded, such that they can both be used to create high-value products. The cellulose recycling processes described herein focus on the preservation of the molecular structure of both the synthetic polymer (e.g., polyester, PET) and the cellulose from cotton, without any substantial degradation of either component. As such, these processes provide a non-degradative dissolution approach to separate cellulose from polycotton blends and other cellulose-containing materials. Various known approaches involve the degradation (e.g., dissolution) of at least one of the target components (i.e. cellulose and polyesters) of the cellulose separation process and are thus not ideal. In contrast, in accordance with the principles of the present invention, novel blends of molecular solvents including organic solvents or water, with ionic additives, which can include the organic salts known as ‘ionic liquids’, are proposed for the purpose of dissolving cellulose or recycling blends of cellulose-containing materials, coupled with novel approaches for recovery of the solvents after the spinning of fibres. One advantage of the proposed system and processes is that it can integrate with the solvents being used in the initial process for separating unwanted polymers, wherein the solvent in the first process becomes the “co-solvent” component of the second process. Additionally, the additional molecular co-solvent component enables a lower solvent cost, better dissolution kinetics, and lower viscosity for processing and agitation and provides the possibility to dissolve cellulose at a lower temperature. Additionally, embodiments of the proposed approach to cellulose recycling focus on the use of cellulose-dissolving solvent mixtures which use more benign solvents, formulated as such to operate at lower temperatures, without the need for cooling to create solutions, giving minimal degradation to cellulose, whilst giving the opportunity for novel solvent-recovery methods, including phase-separation.

In accordance with some embodiments, a cellulose recycling process may involve dissolution of cellulose from cellulose-containing waste materials from pre-consumer or post-consumer sources, including cotton textiles, cotton blended textiles (such as polycotton), rayon (man-made cellulosic fibre) or rayon blended textiles and/or other sources of cellulose such as, but not limited to other blended materials that may include elastane, dyes or other contaminants. The process may further involve utilisation of the resulting dissolved cellulose in solution (dope) to create shaped cellulose articles, such as fibres, films or composites via regeneration in a water-based anti-solvent. One exemplary application of this is the separation of polyester (PET) and cotton blends via dissolution of cellulose first with a solvent for recycling purposes. For example, the dissolution of cellulose occurs with a mixture of a “co-solvent” component, which could be an organic solvent, or water, combined with an ionic additive, which can be various inorganic organic cations and anions. The co-solvent component can also be used in the previously mentioned process for removing “unwanted polymers” from the material, such as a textile blend, prior to the cellulose dissolution and separation process. Optionally, with certain organic solvents as co-solvents and ionic additives, recovery of the solvent from the spinning-bath can take place primarily via phase-separation.

The invention is described further below, with references also to the various embodiments and examples provided for further illustration in the detailed description that follows.

### BRIEF DESCRIPTION OF THE DRAWINGS

The accompanying drawings, which are incorporated in and constitute a part of the specification, illustrate examples of the disclosure and, together with the description that follows, serve to explain the principles of these examples.

FIG. 1 is a block diagram of a modular textile recycling system according to some embodiments of the present disclosure.

FIG. 2 is a block diagram of polyester material post processing portion of a modular textile recycling system according to some examples herein.

FIG. 3 is a block diagram of a cellulose recovery portion of a modular textile recycling system according to some examples herein.

FIG. 4 is a block diagram of another example of a cellulose recovery portion of a modular textile recycling system according to the present disclosure.

FIG. 5 is a block diagram of another cellulose processing Module of the modular textile recycling system herein.

FIG. 6 is an illustrative rendering, provided for scale, of a modular textile recycling system according to some examples herein.

FIG. 7 shows a solvent purification process in accordance with some embodiments of the present disclosure.

FIGS. 8A and 8B show tables depicting test results and predication model results, respectively, for the identification of solvents suitable for the solvent purification process in FIG. 7.

FIG. 9 is a block diagram of further example of the solvent purification process.

FIGS. 10A and 10B show a block diagram of an example process for cellulose extraction by dissolution in accordance with some embodiments herein.

FIG. 11 illustrates an example chemical structure of an ionic additive for the cellulose stripping process.

FIG. 12 shows a phase diagram of a cellulose-dissolving solvent mixture with water.

FIG. 13 shows a table of cellulose-dissolving mixtures that may be suitable for use in the cellulose extraction process in FIGS. 10A-10B.

The drawings are not necessarily to scale. In certain instances, details unnecessary for understanding the disclosure or rendering other details difficult to perceive may have been omitted. In the appended drawings, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label. The claimed subject matter is not necessarily limited to the particular examples or arrangements illustrated herein.

### DETAILED DESCRIPTION

The present disclosure describes a compact modular textile recycling system and associated process for recycling post-consumer and post-industrial textiles into new ready to use fibers for garment manufacturing or other uses. When describing the compact, module recycling plant, the term portion, unit, or module may be used interchangeably to refer to a sub-assembly of the recycling plant, in some cases a single or a set of module units that can be removed and/or interchanged with other unit(s) having a different configuration, and which implement a different process or set of processes, which together form the full textile recycling process from textile waste to new fiber or textile (e.g., fabric, garment, or textile for another use). Inputs to the modular system include textile waste in the form of mixed, unsorted post-consumer and post-industrial textiles. The outputs of the modular system may include one or more synthetic fibers, such as polyester fiber, MMCF (i.e. man-made cellulosic fibre, also known as regenerated cellulosic or rayon) fiber, and in some cases, a finished (e.g., woven, knitted, etc.) bulk fabric or ready-made textile product (e.g., a particular type of garment or other type of textile product). In accordance with examples of the present disclosure, used, mixed composition post-consumer and post-industrial textiles are taken and turned into new ready-made garments, in one compact, modular system and associated processes. The term “used” may imply that the mixed textile supply is comprised of post-consumer or post-industrial textiles. It should be understood that post-industrial textiles may include pre-consumer textile waste. The term “mixed” when referring to the textile feedstock or supply herein may refer to the textile feedstock or supply comprised of different types of textile materials which may be interwoven, knitted, or otherwise fixed (e.g., stitched or glued) together to form a mixed material textile and/or to textiles that combine the different types of materials (e.g., PET, elastane, dyes, etc.) into the fibers from which a particular textile is made (e.g., knitted or woven). In accordance with examples of the present disclosure, the modular system can accept a wider variety of types of textile waste and is configured, in some cases to recycle the textiles, from waste to finished garments in a single system. The modularity of the system enables reconfiguring the system for a particular use or customer segment, enabling it to be more easily integrated into current operations of many different partners in the waste and value chain. Moreover, the modularity of the system enables easy expansion of the system and process embodied therein into additional/different fiber types as needed. However, as textile recycling of multiple different materials may be enabled by the modular system described herein, in some embodiments, the system may be specifically configured to process a used textile input (or supply) primarily comprised of a single type of material (e.g., used polyester fabric, used cotton, viscose or rayon fabric) and/or to produce an output comprised primarily of a single type of material (e.g., recycled polyester or MMCF). That is, in some embodiments, it may be advantageous to configure a portable recycling plant specifically tailored for extracting a single specific material (e.g., polyester, or a cellulose material) and producing recycled fibers of that material (e.g., recycled polyester fibers or MMCF), without preserving or recycling any other components of the mixed textile supply. The system according to some embodiments is designed to have a small footprint (e.g., the size of one or up to a few shipping container sized boxes) and be portable (e.g., substantially fully contained in an enclosure that makes transportation and placement in a desired location easy), such that a fully self-contained automated recycling plant may be co-located with a post-industrial source location (e.g., a garment or other textile product manufacturer or retailer) or other post-consumer textile waste collection point (e.g., Salvation Army, Good Will, or other companies accepting clothing donations, many of which are often unsuitable even for second-hand retail). While described here primarily in the context of clothing recycling, it will be understood that the examples disclosed herein may have application to the recycling of a variety of other textile waste, such as hospital linens, carpet (e.g., remnants or poor quality batches, etc.), and many other types of textile waste.

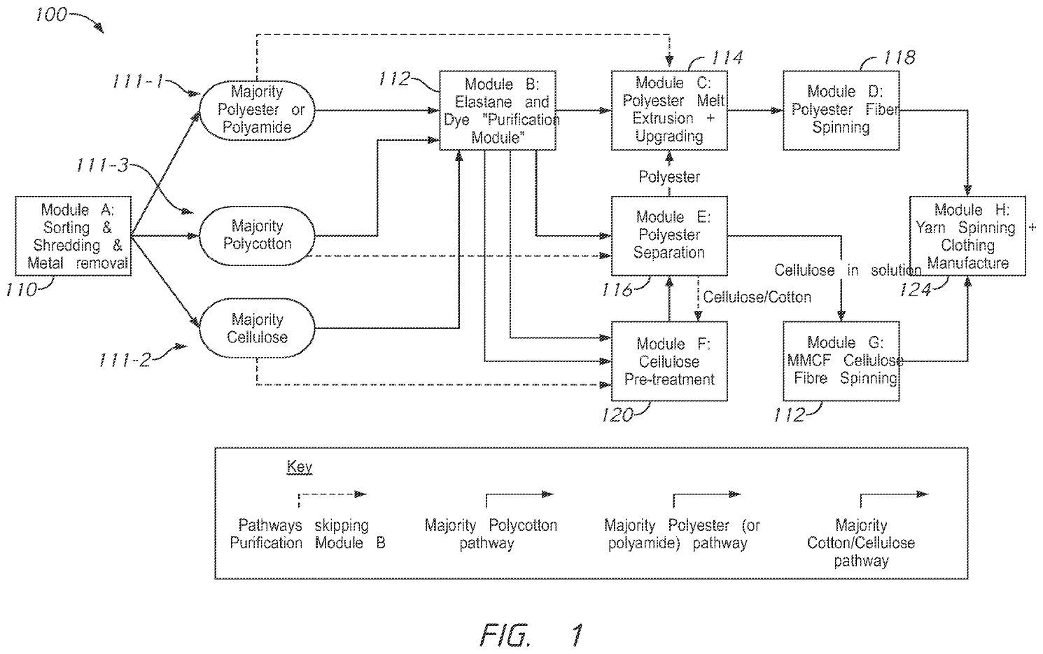

FIG. 1 shows a block diagram of a compact and modular textile recycling system (or plant) according to embodiments of the present disclosure. The system is modular in that subsystems (also referred to as processing blocks or modules) of the larger recycling system can be removed, interchanged, and/or added to obtain a resulting substantially fully contained recycling plant, with different outputs and/or configured to receive different inputs, all within a similar compact scale envisioned by the present disclosure. Such modularity may enable different configurations of the recycling plant to be co-located with different sources of textile waste, the specific configuration of the recycling plant uniquely configured for the textile waste at that location. The terms compact and/or portable herein generally imply a size that is sufficiently small to enable transportation (in some cases, in sub-sections of the modular system) and co-location with the source of the textile waste, such as near a textile/clothing store, hospital, or other. As shown in the example in FIG. 1, the system 100 includes a plurality of modules (e.g., Modules A-I), each of which is configured to perform a specific task or collection or related tasks of the textile recycling process, all arranged together into a compact form factor, such that the recycling process proceeds in a substantially automated manner (without human involvement in the recycling process). While the modular recycling system 100 in the example is FIG. 1 is shown as including a certain number of modules, in other embodiments, the modular recycling system (or plant) 100 may include a different number of modules. Stated differently, one or more of the modules, particularly downstream modules such as the elastane recovery unit (Module I), the yarn spinning, clothing manufacturing unit (Module H), and/or others may be removed and/or replaced with other modules. The system 100 performs processing on a textile supply (e.g., used mixed textiles) to recycle at least a portion of the supply into at least one type of recycled textile fiber(s), which can then be used for clothing manufacture or other uses.

The input into the modular system 100 is textile waste in the form of unsorted or mixed textiles. For example, the unsorted mixed textiles that can be input into the system may include mixed material whole clothing items, single or mixed material postindustrial fabric scraps, single or mixed material rolls or bolts of waste fabric, reject or overproduction material from fiber, yarn, or non-woven textile material production facilities, and/or any other textile fiber waste. In some embodiments, the unsorted mixed textiles may be scraps of fabric of any type (or of different types) which may include impurities, such as synthetics (e.g., elastane, glue, etc.) and non-textile bits such as buttons, zippers, staples, grommets and other metallic or non-metallic components that are frequently added to textiles in a specific application. The output(s) of the system may be one or more different types of fibers (e.g., polyester, such as a polyethylene terephthalate (PET) fiber and/or man-made cellulosic fiber (MMCF)), and in some cases processed (e.g., knitted, woven, etc.) fabric or even a finished garment (e.g., socks, scarves, etc.). The inputs (textile waste) proceed through the compact recycling system in a substantially fully automated manner and are converted to ready-to-use fibers, fabrics or garments, as is described further below. In conventional textile recycling, garments that are not able to be resold for a second use are typically resized or shredded for use in applications such as cloth wipers or stuffing/padding, which is sometimes known as downcycling, turning them into an unrecoverable end of life product. Some fractions of waste, such as good quality cotton and wool free of other polymers or contaminants can also be turned into yarns by “mechanical recycling” methods, but this is limited in scope and typically produces lower quality fibres than their virgin equivalents.

Referring to the example in FIG. 1, the recycling process begins with a sorting process, shown at block 110, and implemented by a sorting module, referred to herein as Module A. The sorting process (block 110) may involve any combination of sorting, cleaning, shredding and/metal removal, as well as any other pre-processing of the textile waste input before it is provided to downstream, chemical processing. The sorting module may be implemented as a mostly electro-mechanical system including one or more mechanical and/or electrical components (e.g., conveyer belt(s), shredder, magnetic demetaler and an eddy current non-ferrous ejector, NIR or hyperspectral camera and associated algorithms for object recognition in the sorting process, etc.) operatively arranged to sort, clean (various contaminants), and shred textiles in preparation for solvent processing. Different configurations of the sorting module may be provided in the system 100 of FIG. 1 depending on the source of the waste (e.g., post-consumer mixed material clothing waste vs post-industrial single material fabric waste) expected to be input into the system. As such, and depending on the configuration of the system (e.g., the input fabric waste expected), the NIR or hyperspectral camera and associated sorting algorithm may be differently configured. The sorting process may involve sorting textile components from non-textile components in the textile waste input, and in some case additionally and optionally sorting the textile waste into different waste processing streams based upon the textile composition (e.g., separating polyester containing textile waste from textile waste that does not contain polyester).

The sorting module may perform an initial cleaning, for example using CO₂ and/or other industrial (e.g., green) dry-cleaning techniques such as when the system is utilized for the recycling of textiles of unknown cleanliness. The mixed textile waste may preliminarily be roughly sorted at the garment level in embodiments configured to recycle clothing. In other embodiments, an initial sort based on some other macro category of the textile waste may be performed. A combination of an NIR or hyperspectral camera for identification of materials, followed by a mechanical resultant action that sorts the clothing items into major categories may follow the cleaning step to optimize the output of the sorting module for chemical processing by the downstream modules (e.g., modules B, E, and F, which will be further described below). In some embodiments, the sorting process may utilize one or more machine learning models, properly trained to identify, from the images captured by the camera directed to the appropriate portion of the conveyor system, different types of fabrics, fabric compositions and/or contaminants. A batch of materials is then shredded into ‘confetti’, for example of approximately 1 cm×1 cm size. The resultant shredded material (or confetti) may then be sorted by density. Any suitable density sorting technique may be used. For example, the shredded material may be spread appropriately (e.g., lengthwise along the conveyor belt) and may pass across a gap that includes moderate airflow, separating denser materials (e.g., buttons, zippers, ‘corners’) from the fabric materials. Additionally or alternatively, a magnetic demetaler and an eddy current non-ferrous ejector unit may be used to remove smaller metal contaminants.

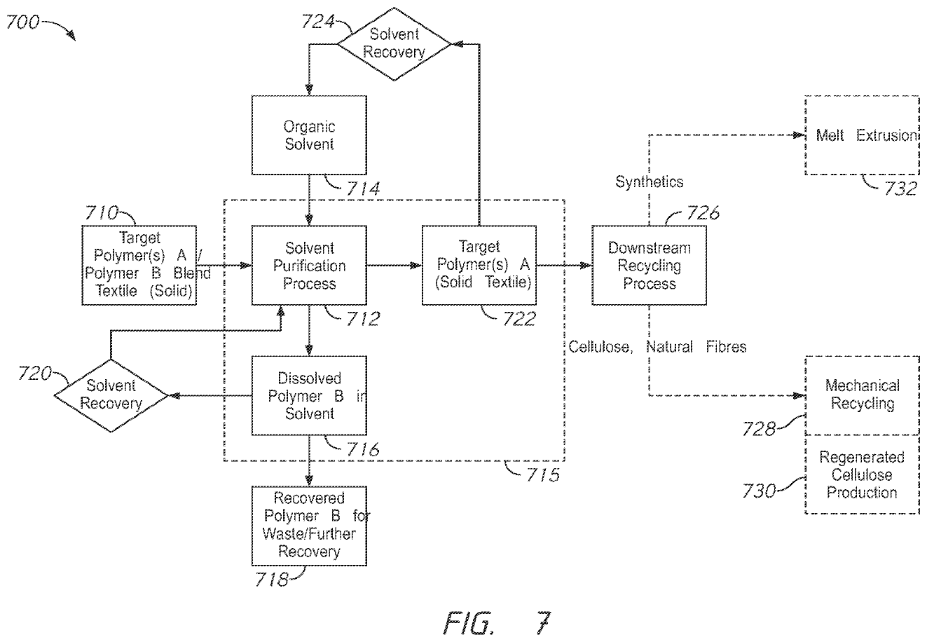

As noted, the sorting module 110 may be configured to receive, as input, textile waste in the form of mixed textiles, sorting and pre-processing the textile waste in a manner that separates the textile waste into a predetermined number of waste streams, each optimized for the particular type of downstream processing (e.g., chemical processing). The sorting module 110 may produce, as output(s), cleaned shredded textile waste, with denser materials (e.g., buttons, textile edges, ferrous and non-ferrous waste etc.) separated out, and with shredded output further sorted by type of material (e.g., polyester, cotton-poly blend, etc.) such that the different types of shredded textile materials can be diverted to a suitable downstream module for further processing. For example, in the embodiment in FIG. 1, the output (e.g., shredded textile waste) is separated into three different categories of textile waste, each of which is coupled to a different downstream processing path and associated processing module(s). That is, in the example in FIG. 1, the single input stream of mixed textile waste provided to Module 110 is initially processed and sorted into 3 output streams of shredded textile waste, including a first output stream 111-1 or category that contains substantially only (or majority) polyester blends of textiles (e.g., poly/elastane blends or substantially only (or majority) another synthetic such as nylon or polyamide/elastane blends). A second output stream 111-2 contains substantially only (or majority) pure cellulose-based materials (e.g., 100% cotton, viscose or rayon textiles), optionally with small amounts of another material, such as elastane. A third output stream 111-3 contains substantially only (or majority) a mixture of polyester and cellulose (e.g., cotton) in any proportion, optionally also with small amounts another material, such as elastane. The output stream 111-2, containing cellulose but also polymers such as elastane, can first be optionally treated in module 112. The output stream 111-3, containing polyester and cellulose (i.e. polycotton) but also polymers such as elastane, can first be also be optionally treated in module 112. In some embodiments, the majority polycotton stream (111-3) may proceed directly to module E and/or the majority cellulose stream (113-2) may proceed directly to module F as shown by the dotted process flow lines in FIG. 1. However, as noted above, in some embodiments any of the different output streams may first be passed through a solvent purification process (e.g., module B and/or as further described with reference to FIG. 7) to remove elastane, soluble dyes, soluble organic chemicals and other contaminants before further downstream processing. Passing the different textile waste streams through the purification process may be advantageous since amounts of elastane in low concentrations can be difficult to detect by known techniques.

In some embodiments, optionally, the polyester blends that include additional man-made materials such as elastane, acrylics, etc. are diverted along one path (e.g., the first processing path 111-1), while polyester blends containing cotton, referred to also as polycotton blends, are diverted along another processing path, shown in FIG. 1 as the third processing path 111-3.

The polyester-cotton (or polycotton) blends may be processed using different solvents and/or using different sequences of applying the solvents, in the third processing path 111-3 as compared to the first processing path 111-1, e.g., via the cellulose dissolution/polycotton extraction process described herein. As further noted, the polycotton blends may also be treated in Module B (e.g., by a solvent purification process) to remove undesired components (e.g., elastane, dyes, etc.).

In some embodiments, the first processing path 111-1 is tailored to solve the recycling problem for the polyester material and thus extract unwanted polymer contaminants, such as elastane with minimal or substantially no degradation of the polyester material, preferably without decomposing the polyester textiles into its building blocks, whereas the third processing path 111-3 is tailored to solve for the cellulose material, whereby the polyester output from the processing in path 111-3 would be a secondary output product as opposed to the primary output from path 111-1. This secondary output is then connected to the first stream 111-1 on Module C (114). In other embodiments, the portable recycling plant may be specifically configured to process a single waste stream. In such embodiments, the sorting module may perform one or more of the pre-processing steps described here but rather than diverting one or more portions of the textile waste to different processing paths, all of the sorted and pre-processed textile waste may be supplied to a single downstream processing path optimized for the recycling of the particular type of textile waste expected as input.

Referring back to the example in FIG. 1, the first output stream of shredded textile waste diverted along waste processing path 111-1 is provided next to Module B, shown as block 112, where the textile waste undergoes a process in which a secondary material component of the mixed composition textile waste (e.g., elastane, polyurethanes, acrylic, cellulose acetate, dyes, additives, coatings and other soluble materials) are separated from one or more primary material components of the mixed composition textile waste. Module B performs a process that separates the secondary materials (e.g., elastane) without substantially degrading (e.g., without chemically decomposing) the primary material (e.g., the polyester) such that the separated primary material (e.g., the polyester) can be repurposed into renewed or recycled fiber (e.g., renewed/recycled polyester fiber) via further downstream processes (e.g., via Modules C and D). In some embodiments, Module B is further configured to separate a second (e.g., cellulose) material from the primary (e.g., polyester) material, and the separated second material (e.g., cellulose) can also be recycled (e.g., into renewed cellulose-based materials such as MMCF) by further downstream processes of the system 100. In some embodiments, Module B is configured to remove dyes, elastane, acrylic, and other finishes and impurities with a solvent via the means of continuous solvent extraction, that is selective for these, but does not dissolve polyethylene terephthalate (interchangeably referred to here is as PET or polyester). By not dissolving the PET, further downstream processing is simplified and costs reduced. Thus the recycling of PET is less energy and carbon intensive than other ‘chemical’ recycling methods. In other embodiments, the same or similar arrangement of Module B (e.g., using continuous solvent extraction) can be configured to purify a different type of textile material and/or remove different “impurities.” For instance, in the example of carpet textiles recycling, Module B may be configured to remove glue or other impurities from wool, polyester or polyamides or other types of fabric or fibre(s) commonly used in carpets.

In some embodiments of the invention, and because of the specific mechanical properties of textiles and the way that they shred into porous, non-homogeneous layers of materials, Module B provides a unique mechanical solution to impregnate and remove solvents and dissolved elements from garments. This solution can be used to impregnate a suitable solvent into polyester blends to remove impurities therefrom or it can be tailored for processing different types of fabrics and/or to remove different impurities than the specific examples described in detail herein.

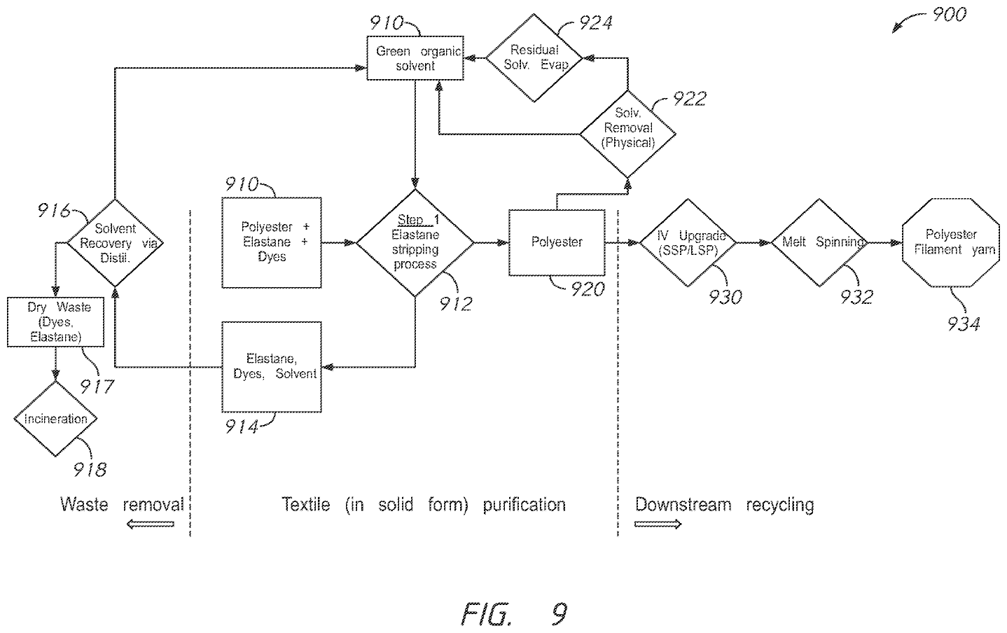

In some embodiments, the shredded textile materials are conveyed on a permeable screen through a series of varying velocity solvent streams (or ‘blades’), which may range from gravity flowing rates up to those similar to pressure washers. The path that the permeable screen follows to convey the textile materials through the blades may be substantially straight or it may be circuitous, such as be looping or switching back and forth within a volume that extends vertically to provide a more compact footprint. The increased force of the solvent traveling through the textile materials in the later ‘blades’ aids to carry with it the elements intended to be removed from the textile. The cleanest solvent is used in the final ‘blade’, and would be preferably recovered from that blade, and used for the previous blade, moving its way in reverse direction with respect to the travel path of the textiles being conveyed through the recycling plant. The ‘dirtiest’ solvent thus would be the first solvent to come in contact with the textiles, in such embodiments. After being recovered from its first contact with the textiles, the solvent may be provided into a continuous recovery and extraction unit to purify it and return it to the final blade as cleaned solvent, creating a closed loop solvent system with substantially no wasted solvent. In other embodiments, the textiles are treated in a continuous flow submerged screw counterflow solvent immersion process whereby the shredded textile material is mechanically advanced through a solvent bath by means of a rotating screw where the solvent is flowing against the travel direction of the textiles. Various embodiments are described in further detail below with reference to the solvent purification processes illustrated in FIGS. 7 and 9, including a continuous extraction system based on conveyers and sprayed solvent or solvent immersion, augurs with a counter-flow of solvent, or in a batch-wise fashion in a vessel with horizontal or vertical agitation. Additionally, a soxhlet-type extractor can also be used.

In some examples, inputs to Module B may include PET fabric, Cellulose (cotton, rayon) fabric, and other fabrics (e.g., wool, nylon, etc.), any of which may contain elastane, acrylic, dyes, and other finishes that are removed during the recycling process. As a result, Module B may output PET, cotton, and/or other fabrics, such as but not limited to wool, nylon or polyamides, which are substantially free of dyes, elastane or other polyurethanes, finishes, soluble chemical compounds and/or any other synthetics.

In the context of an example where impurities are removed from polyester, the solvent is selected such that it does not dissolve polyester in the elastane dissolution temperature range, and when selected appropriately, can be benign in terms of safety and environmental impact. In embodiments of the present disclosure, the boiling point of the solvent is selected to be close to that of the solvent stripping temperature, thereby saving energy in the solvent recovery step. The solvents are not heated to high temperatures, and PET is therefore not dissolved—this reduces degradation of the polymer chains due to high temperatures and saves the need to remove traces of solvent from the molten polymer, saving energy. Additives such as TiO 2 will be preserved, saving further downstream processing cost. Module B can also be used to separate certain dyes and elastane from cotton products, such as denim, to interface with Modules F and G. Module B can also be used to separate other blended textiles, which include blends with acrylic, other polyurethanes (including adhesives, coatings and membranes) and cellulose acetate. Examples of solvent purification processes that may be used to implement aspects of Module B are described further below, e.g., with reference to FIG. 7.

Generally, and continuing with the present example, Module C is configured to use the polyester output of Module B, and prepares it for melt extrusion of pellets or yarn. In some embodiments, the intrinsic viscosity (IV) of the polyester is increased, e.g., by liquid state polycondensation (LSP), by the application of a vacuum. Other suitable processes for increasing the IV of the polyester may be used. Generally, due to degradation in the spinning and consumer lifecycle, a lift in IV may be advantageous to spin good quality fibers in the downstream Module D. In combination with Module B, e.g., by receiving the polyester output of Module B, substantially all contaminants are removed including water, which could otherwise interfere with a liquid-state polycondensation for IV upgrading. By removing the impurities in Module B, PET can be heated to a high temperature, under vacuum, in order to pull off excess ethylene glycol and/or water, increasing the molecular weight of PET thereby increasing and upgrading the IV. Moreover, an added technical advantage of achieving polycondensation may be obtained from the same process used to transform ‘fluffy’ textile scraps and waste into a denser form better suited for extrusion, thus combining two steps into one.

In some examples herein, Module C receives, as inputs, the output(s) of Module B, specifically the PET material free of dyes, elastane, finishes, and the rinsing solvent, and/or output of the polycotton separation Module E as a PET melt. The material input into Module C may undergo compacting/densification. Module C may include, among other things, a screw-type extruder chamber, a chamber to generate a large surface area for the PET melt with vacuum attachment to enable condensation, and may be equipped with online monitoring of IV to control residence times. Additionally a changeable (or replaceable) filter screen may be used for filtering any solid contaminants out of Module C. Module C may provide pelletized PET as output, and/or a PET melt which may be supplied to Module D for Polyester fiber spinning.

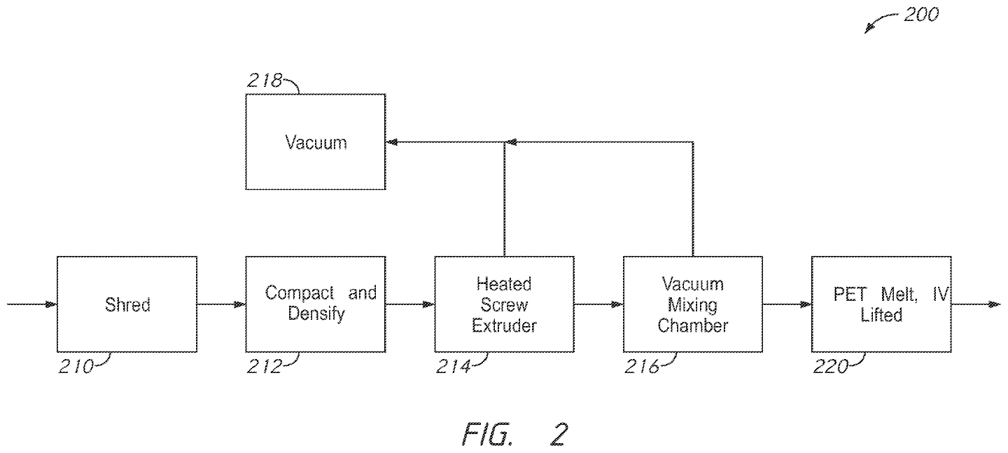

FIG. 2 shows a block diagram 200 of one embodiment of Module C, which may be used to implement block 114 of FIG. 1. In the example in FIG. 2, Module C is configured to increase the intrinsic viscosity (IV) of the polyester material, and may thus be interchangeably referred to as Polyester IV upgrade and extrusion module. In other embodiments, a different method may be used, or the polyester material may proceed directly to the PET extrusion/IV uplift stage. The process in FIG. 2 begins at block 210, which may involve size-reducing the output of Module B (PET) after removal of the unwanted material(s) (e.g., dye, elastane and finishes removal) and thereafter densifying the size-reduced output of block 210. In some cases, PET is additionally received from Module E as a result of the polycotton separation process performed therein. Next, the densified polyester textile is subjected to heat (block 216) in order to form a melt state, typically in a form of melt extruder. In the preferred embodiment, the melt-state PET is subjected to a vacuum, as shown in blocks 216 and 218, and optionally an inert atmosphere with agitation to increase the molecular weight via polycondensation. The IV-increased, melt state PET (see block 220) is then suitable for either pelletization, suitable for reprocessing, or to be taken directly to fiber and yarn spinning in Module D. In another embodiment, the densified polyester pellets or melt-extruded pellets are subjected to solid-state polycondensation rather than in the melt state, with a combination of heat, and optional inert atmosphere over a specified time period. The PET melt may be received by Module D and form PET filaments (or fibers) and yarns. In some embodiments, known and/or commercially available equipment or techniques may be used to implement certain aspects of Module D, such as the fiber and/or yarn spinning.

Referring back to FIG. 1, the shredded textile waste materials that include substantially only poly/cotton blends are diverted to the processing path 111-3 and are provided to a polycotton purification/separation unit, referred to as Module E for simplicity, and shown at block 116. The process implemented by Module E is configured to separate cellulose and PET present in polycotton textiles, outputting a dissolved cellulose in solution (a “cellulose dope”), which may be provided directly to the cellulose fibre spinning module G. In other embodiments, a pure cellulose or regenerated cellulose material may be output from Module E. The process may also output PET fabric, free of cellulose, to head to the polyester fiber densification and extrusion module (e.g., blocks 114 and 118). Module E may optionally be used for polycotton after its treatment in Module B to remove dyes, finishes, and other polymers such as Elastane and Acrylic.

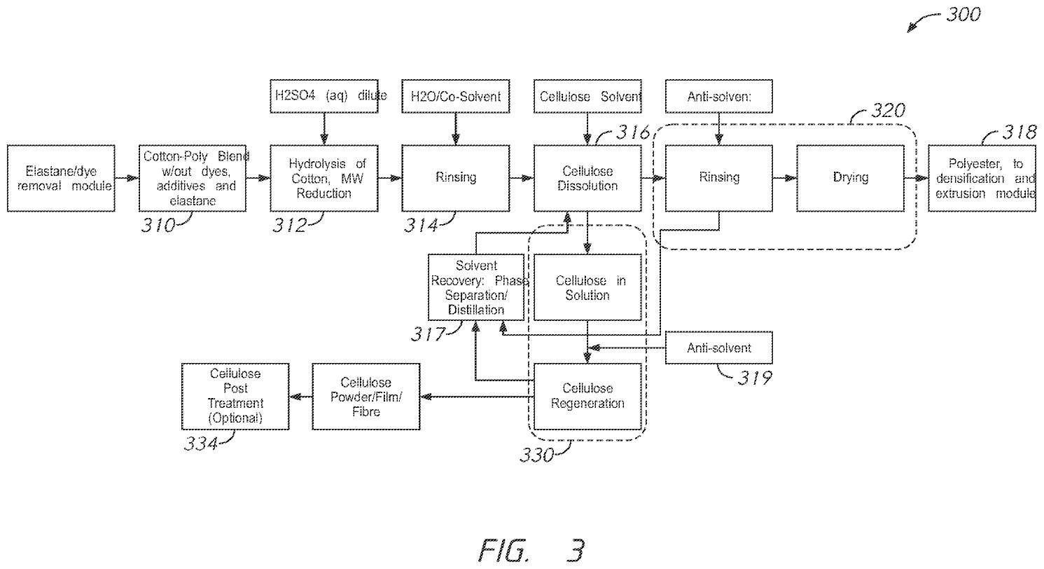

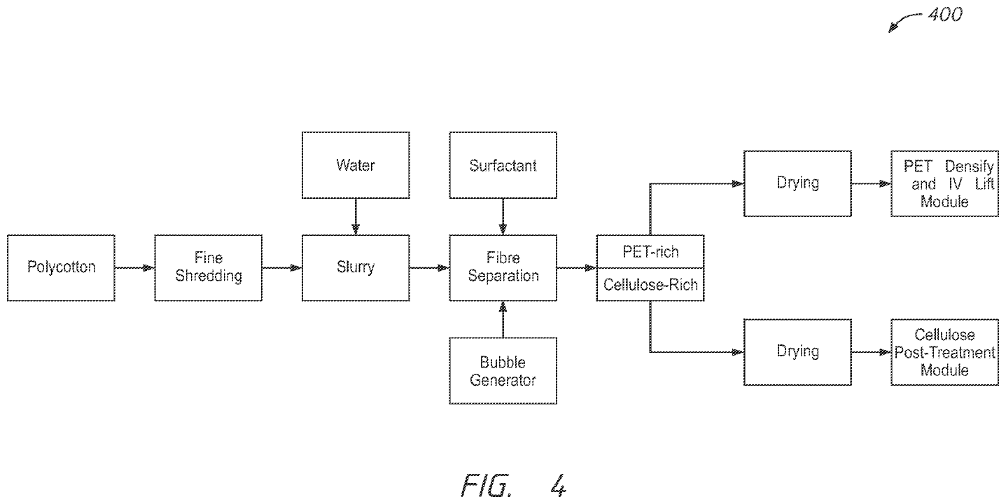

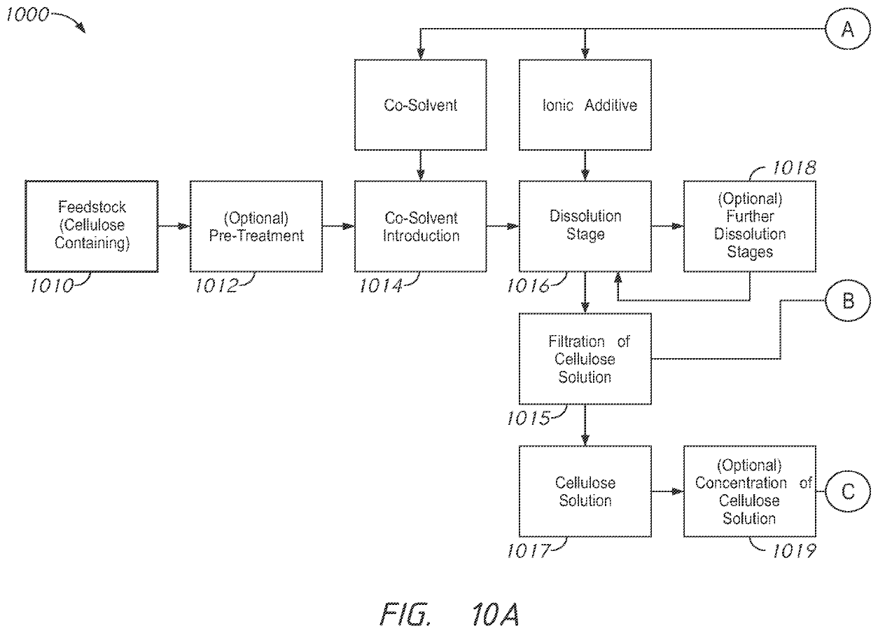

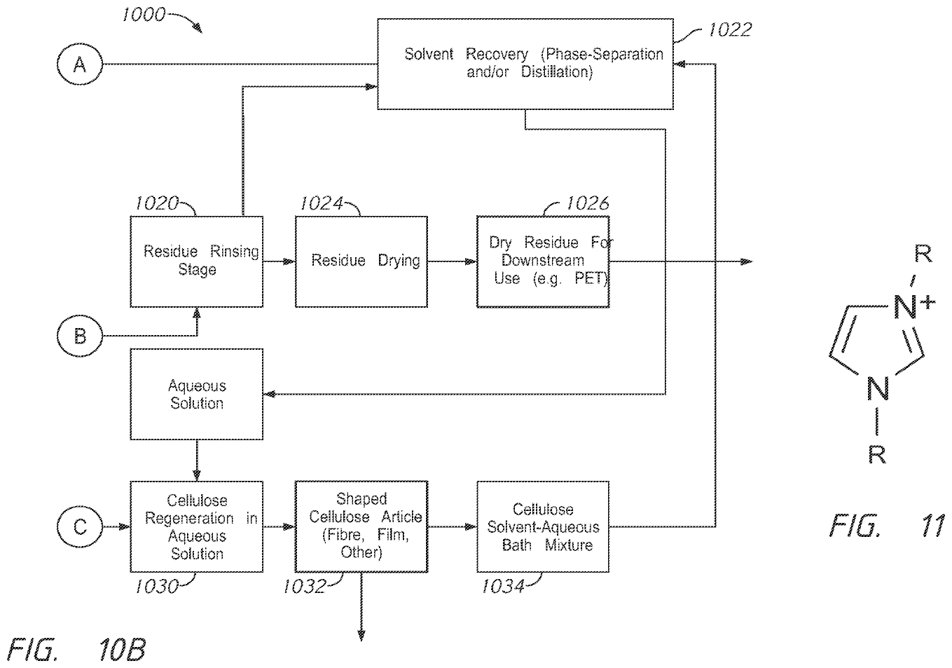

Module E (block 116), which may also be referred to as polycotton separation module, may be implemented using a number of different approaches. For example, in one embodiment, as shown in the block diagram 300 in FIG. 3, the polycotton separation is done by dissolution of cellulose from the input textile waste. In this approach, the cellulose is dissolved by means of a cellulose solvent, such as an aqueous or organic electrolyte solution, or ionic liquid. This approach could be adapted to use the Module B (block 112) solvent stripping apparatus to impregnate the solvent and dissolve the cellulose component of polycotton. After the cellulose is removed, the PET fabric is rinsed and dried and carried to Module C (block 114) for further processing. In one embodiment, the cellulose is precipitated from the solution (regenerated) by means of a water-based anti-solvent, and the solvent is recovered in a solvent recovery unit. The form of the regenerated cellulose may vary, but can be a powder, film, or mixed with another material as a composite. In another embodiment, the cellulose in solution is brought directly to the MMCF spinning module (e.g., Module G, shown at block 122) for wet-spinning of a regenerated (or man-made) cellulosic fibre. Embodiments of a polycotton separation process by means of dissolving the cellulose-portion of the blend with organic and aqueous solutions are described with reference to FIG. 4 and also further below, e.g., with reference to the cellulose extraction/recycling process illustrated in FIGS. 10A-10B, and 11.

Referring to the block diagram 400 in the example in FIG. 4, the polycotton textile, having any soluble dyes and elastane removed, is brought into the polycotton separation process, as shown at block 410. In an alternative embodiment, Module B can also be connected at the end of Module E. Prior to dissolution, a dilute acid or enzymatic hydrolysis process (block 412) reduces the molecular weight of the cellulose in cotton in Module F (120) or the pre-treatment module (120). This stage may optionally be before the dye and elastane removal stage in Module B (112). After removing any residual acid (block 414), and the polycotton textile is both free of soluble dyes and elastane, a cellulose-dissolving solvent mixture is introduced (block 416). This cellulose dissolving solvent is an aqueous or organic electrolyte solution in some embodiments. The cellulosic component of the polycotton textile is dissolved in the solvent, e.g., in atmospheric conditions, or in other embodiments, with the addition of heat. The residual polyester fabric (blocks 420), free of cellulose, is separated from the cellulose solution (blocks 430), with a method such as, but not limited to, filtration, mechanical action, with or without the assistance of an additional solvent.

Any solvent is removed from the polyester fabric by a method such as evaporation, preferably at a temperature sufficient to minimize degradation of the polymer chains. The polyester fabric is free of any cellulose, dye and elastane (see block 418) and is forwarded to Modules C (114) and D (118) for densification, melt extrusion and filtration, and if required, filament spinning. The cellulose-containing solution can then be processed in two ways. In one route, a solvent (the “anti-solvent”) is added (with or without additional additives, such as salts and acids) to the cellulose-containing solution such that the solubility is lowered, causing the cellulose to precipitate out of solution (also known as regeneration). The regenerated cellulose is then separated by filtration or another separation method. The regenerated cellulose is washed with a combination of solvents and/or water and is optionally dried. The solvent and ‘anti-solvent’ mixture is recovered by a method such as distillation, phase-separation or filtration (block 417), with the anti-solvent being removed (block 419) to a level where the solvent is capable of dissolving cellulose and the anti-solvent is separated from the cellulose solvent for use again. In an alternative pathway, the cellulose-containing solution is sent directly to the wet fiber-spinning Module G for direct spinning of a cellulose fiber.

In another embodiment, the separation of cellulose may be done by glycolysis or partial-glycolysis of PET, an example flow diagram 400 of which is shown in FIG. 4. In this approach, ethylene glycol is used to partially glycolyse the PET. The glycolysate can then be separated from cotton via filtration. This can be re-polymerized in Module C in the vacuum LSP chamber, or polymerized in a separate chamber and combined upstream in Module C, forming one flow of PET melt to the extrusion modules. Excess ethylene glycol is removed from the cotton, and then dried, and sent to Module F for further processing. The example in FIG. 4 shows an example Module E configured to perform Polycotton Separation by Density and Surfactant-Aided Bubbles

In yet another embodiment, the separation of cellulose may be done by density. In this approach, after a hydrolysis pretreatment and fine shredding/grinding, cellulose and polyester are separated by density. This can be achieved through the use of a bubbling action with a surfactant, thereby separating the textiles into a polyester rich and cellulose rich fraction, which can be sent to either Module B or F for further processing.

Referring to FIG. 1, the recycling system 100 may include a cellulose pre-treatment Module, labeled for simplicity as Module F, and which defines, in part, a textile waste processing path 111-2 of the recycling plant for processing substantially pure cellulose-based materials or additionally cellulose-containing materials, such as polycotton blended textiles. Module F receives as input the shredded textile waste sorted to contain substantially only cellulose based materials (e.g., 100% cotton, viscose, or rayon) as output from the sorting Module A and/or cellulose-containing material from the processing path 111-3, e.g., polycotton blends. Both streams may optionally have been processed through module B (112) to remove elastane, dyes and other materials. This pre-treatment module may additionally receive polycotton blended materials (stream 111-3) before Module E (116), to pre-treat the material before polycotton separation. In another embodiment, module F can also be reconfigured as a post treatment module, taking cellulose or regenerated cellulose material after separation in module E.

The cellulose pre-treatment process in module F (block 120) may include one or more of the following cellulose pre-treatment steps, in any suitable order:
Molecular Weight Reduction, which may include any combination of the following, in any suitable order: Dilute acid hydrolysis with a mineral acid, Enzymatic hydrolysis, Ozone treatment, Electron beam or plasma (high energy) treatment, and Ripening in sodium hydroxide;
Bleaching by any suitable method, with any combination of the following, in any suitable order: Ozone treatment, with or without additives, Reductive bleaching treatment, with Sulphur based reagents such as thiourea, thiosulphate, sodium borohydride, sodium hydrosulphite and others, Oxidative bleaching treatment, such as, but not exclusively, sodium hypochlorite or other chlorine based bleaches or peroxide based bleaches;
Swelling pretreatment with any combination of the following: Sodium hydroxide, Ionic Liquids, Organic or Aqueous electrolyte solutions, and Amines; and
Residual Metal Removal using any suitable combination of Acids including carboxylic acids, and/or EDTA or other chelating agents.

Referring to FIG. 1, the recycling system 100 may include a man-made cellulosic fibre spinning module (122), labeled for simplicity as Module G. In one embodiment, this module receives dissolved cellulose in solution (known as “cellulose dope”) from the polycotton separation Module E (116) and is used to spin man-made cellulosic fibres directly. In this embodiment, the cellulose is optionally pre-treated in Module F (120) before the polycotton separation process. In another embodiment, the module can also receive pure (not dissolved) cellulose or regenerated cellulose from the polycotton separation process.

In some embodiments, Module G (122) receives substantially pure cellulose, i.e. a cotton textile received from directly sorting module A (110) and after pre-treatment in Module F (120), alternatively also after treatment in purification module B (112) to remove elastane, dyes and other contaminants.

In some embodiments, the solvent used in module B to remove elastane and other contaminants may become part of the cellulose solvent (i.e. the molecular co-solvent), in combination with certain ionic additives as explained further below with reference to the “Cellulose Recycling Process” and FIGS. 10A-10B. In such embodiments, the process constitutes a novel direct dissolution solvent system for wet fibre spinning of cellulose. Pre-treatment of the cellulose in Module F (120) can take place before purification in Module B (112) or after.

Alternatively, in other embodiments the MMCF (man-made cellulosic fibre) spinning process in Module G (122) may be other known methods include viscose xanthogentation (viscose fibre spinning), dissolution in NMMO (lyocell fibre spinning) or dissolution in other solvents, such as pure ionic liquids.

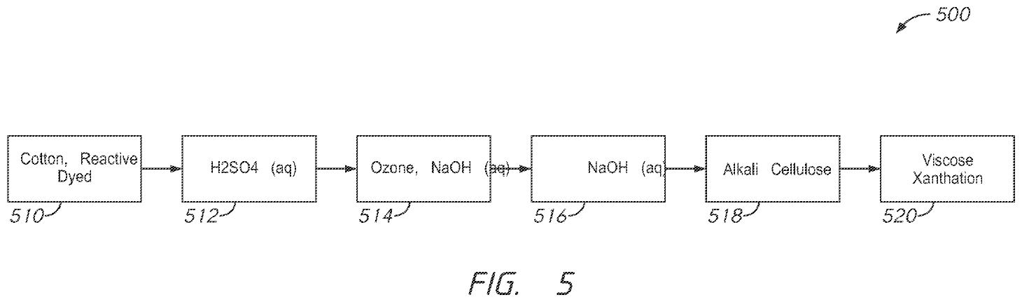

FIG. 5 shows a block diagram of one embodiment of the cellulose pre or post-treatment process 500 that may be implemented by Module F and Module G together (e.g., block 120 of FIG. 1). The process 500 may be used to prepare the cellulose output from Module B and E as well as incoming pure cotton or rayon garments, fora subsequent cellulose dissolution and fiber spinning process. The process 500 may receive as inputs Cotton and Rayon textile optionally with soluble dyes, elastane, other finishes removed and may output Dye Free, Molecular Weight Reduced, Pre-Treated Cellulose. In the specific example shown in FIG. 5, Module F is configured to receive a reactive-dyed cotton input (block 510) where a viscose fiber spinning line is provided as Module G (at block 520).

In the specific example in FIG. 5, the process 500 includes a molecular weight reduction step (block 512), a bleaching step (block 514), which in this example is performed by ozone treatment, a swelling pretreatment step (block 516), in this example using Sodium hydroxide, and a residual metal removal step (block 518). In other examples, the process 500 may be performed using any other suitable combination of steps.

A finishing module, shown as block 124 and also referred to as Module H, may be configured to produce a finished ready to use fiber, fabric or garment. In some embodiments, this module may be configured to spin one or more manmade fiber(s) output from upstream components of the system. In some embodiments, the finishing module may alternatively or additionally be configured to produce fabric such as by knitting or weaving the manmade fibers. In yet further embodiments, the finishing Module may alternatively or additionally be configured to produce ready to wear garments such as by knitting or the manmade fibers. The function of Module H is to transform raw fiber into yarn to be used in clothing. The yarn can then be used to knit fabric, or even be knit directly into final products like seamless clothing such as socks, leggings, shirts, scarves, or other accessories. This small scale production of end use consumer goods is not in and of itself a key invention, and would use equipment currently commercially available.

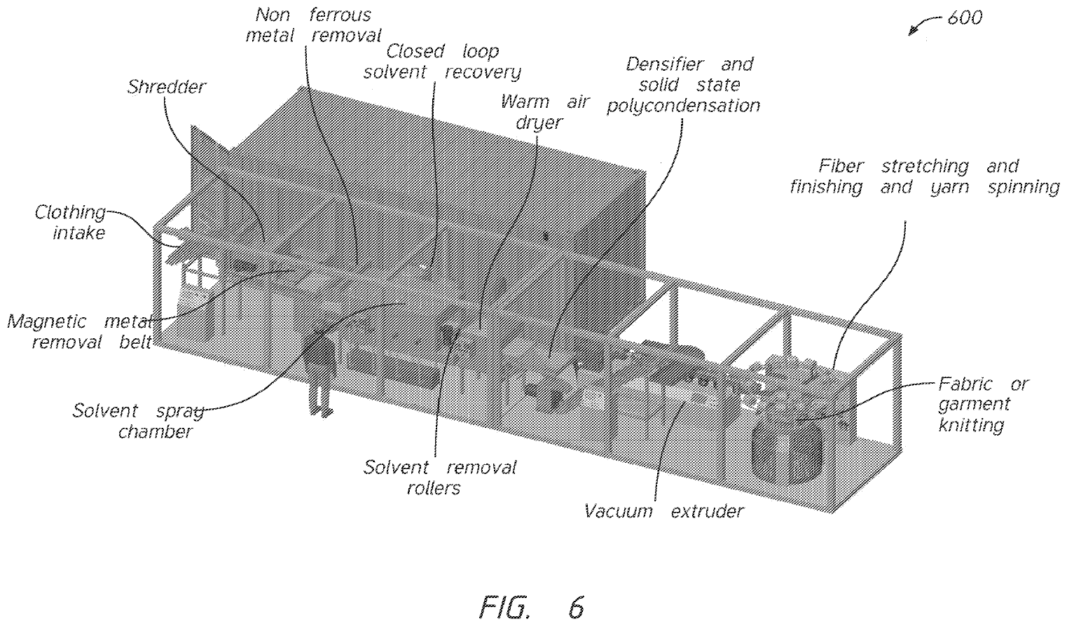

Referring to the rendering in FIG. 6, and for the appreciation of scale, a modular recycling plant 600 according to the present disclosure may be implemented within a box or enclosure roughly about the size of a shipping container. In some embodiments, and depending on the desired output, the modular recycling plant may be as large as the size of two or three shipping containers. The ultimate footprint of the modular recycling plant, whether sized to fit in a single or a plurality of shipping containers would be orders of magnitude smaller than an industrial facility built for the recycling of textile waste and thus would facilitate wide distribution of these compact modular recycling plant to any source of waste textile, where they can be co-located with the source removing the need for transportation of the waste materials to a centralized recycling facility.

Solvent Purification Process

FIG. 7 shows a flow chart of a solvent purification process 700, which may be used, in some embodiments, for removing unwanted polymer material(s) from desired polymer material(s), such as to prepare the desired polymer material for downstream recycling processes. The process 700 may be used to implement Module B (block 112) of the system shown and described above with reference to FIG. 1. It will be understood that in some embodiments, this solvent purification process 700 may be used entirely separately (or independently) from any downstream recycling processes or in combination with various other recycling process different from the ones described herein.

As shown in block 710, the process 700 starts by providing a feedstock of material. The feedstock is a blended textile or mixture of textile materials containing a target polymer or mixture of target polymer(s) A (e.g., for use in further recycling), together with one or more undesired (or unwanted) materials B, such as an undesired textile fibre polymer(s) and one or more other chemicals (or contaminants). The target polymer(s) A may include, but is not limited to, a Polyester such as PET and others, a Polyamide such as Nylon 6 and Nylon 6,6 and others, Cellulose such as Cotton, Rayon, Wool, etc., and others. The undesired polymer(s) B may include, but are not limited to, elastane, polyurethanes, acrylic, cellulose acetate, or others. The undesired material(s) may include, without limitation, soluble dyes, including disperse dyes, as well as other organic and inorganic coating, additives, and other auxiliary chemicals. In some embodiments of the process, the material is a polyester-elastane, polycotton-elastane, or cotton-elastane blended textile (in streams 111-1, 111-2, 111-3) of the wider recycling system, as received from Module A (110) after sorting. In some embodiments of the process, the material can also be a nylon-elastane blended textile of the wider recycling system, as received from Module A (110) after sorting, which would be fed into a separate downstream module homologous to modules C and D, but configured for polyamides or nylon instead.

An organic solvent (block 714) is provided to initiate the solvent purification process (see block 712). In some embodiments, the organic solvent preferably has a boiling point below the melting point of the target polymer(s) A and selectively dissolves the unwanted polymer(s) and other chemicals (or contaminants), referred to as B, in the same temperature range. Organic solvents suitable for this process may include cyclic ketones of a general structure (CH₂)ₙCO where n=4,5,6,7) or aprotic solvents including dimethylsulfoxide, N-Methyl-2-pyrrolidone, dimethylacetamide, dimethyl formamide, as well as bio-based alkyl esters, such as alkyl lactates (ethyl lactate), as well as tetrahydrofurfural alcohol, diacetone dialcohol and isophorone.

In block 712, the solvent is contacted with the blended textile or mixture of textile materials, with the application of heat, in a range from 60-200° C., in order to dissolve and hence remove the undesired polymer(s) B and leave the desired polymer(s) A undisturbed, in a solid textile form. The solvent contacting can be performed in a batch-wise fashion, with specific residence times. For example, the organic solvent may be contacted to one or more batches of the feedstock, and be in contact typically not more than 1 hour, and preferably less than 30 minutes per batch, until the undesired polymers and other materials are depleted. In some embodiments, the contacting may be in a continuous flow-through fashion until the undesired polymers and other materials are depleted. In some examples, the organic solvent is sprayed onto the textile material, in some cases in a continuous fashion as the textile is advanced on a conveyor through a recycling system module. The contaminated solvent may then be collected and recycled as further described below. In some examples, the textile material (i.e., the feedstock) is submerged in a vat, optionally in batches. In some examples, the conveyor moving the feedstock through the module may submerge the feedstock into the vat containing the organic solvent. The undesired polymer(s) along with other soluble (e.g., undesired organic and inorganic contaminants, including soluble dyes (such as disperse dyes), finishes, coatings and additives) B are dissolved in the solvent (block 716) forming a contaminated solvent solution containing the organic solvent and the dissolved undesired material(s) B, which can then be removed from the textile to separate the undesired components B from the textile containing the desired polymer(s) A. In some embodiments, the contacting and consequently the separation may involve supporting the textile on a screen (or filter) while contacting, such that the contaminated solvent solution passes through the textile feedstock and screen and is collected, optionally for recycling. In some embodiments, force may additionally be applied to the wetted textile to press the solvent solution out of the wetted textile and collected optionally for recycling into the purification process. Various processes for separating the contaminated solvent with the dissolved undesired materials B from the textile (at block 715) may be used, at different stages.

In some embodiments, at least a portion of the organic solvent may be recovered (block 720) and optionally preferably recycled into the solvent purification process (block 712). The organic solvent may be recovered from the dissolved polymers (B) and other soluble contaminants by a suitable recovery method, for example distillation. The recovered solvent from block 720 may be provided back into purification step (at block 712), which involves heating the organic solvent recovered at block 720. In some embodiments, additionally or alternatively, the organic solvent may be recovered at block 720 by one or more other suitable processes including, but not limited to, filtration. At block 718, the undesired polymers and other contaminants may be recovered as a solid, dry waste stream which can be treated, for example via incineration with energy recovery. In some embodiments, the undesired polymer can, additionally or alternatively, be recovered from the waste stream by an additional downstream recovery step.

After separation of the bulk of the contaminated organic solvent (e.g., the unwanted polymers and other contaminants B dissolved in the solvent), the targeted polymer(s) A now exist in a solid textile form as shown at block 722, with no or minimal degradation of the textile, minus the undesired polymers B. Residual organic solvent may remain in the textile material after separation of the bulk of the solvent from the textile material, which may be removed via any suitable method or combination of methods. In some embodiment, a physical removal method, such as via a pressing or centrifugal force, may be used first to remove remaining solvent. Various mechanical ways for removing solvent, either at this step 722 or at steps 712 and 716, may include the use of a graduated augur press, a screw press, a roller press, a hydraulic or pneumatic filter press, or centrifuge, which are operatively arranged to apply a force on the purified textile for the removal, and optional collection/recovery of the solvent (see also block 724). The physical removal step may be followed by 1) evaporation of any remaining solvent from the textile, in some cases optionally in combination with the application of heat, airflow, and/or vacuum, and/or 2) a solvent exchange with a solvent having a lower boiling point than the organic solvent used for the purification step. Examples of such solvents include, but not limited to, methanol, ethanol, and acetone.

Following step 722, the desired (or target) polymer(s) A may now be in substantially dry, textile form, ready for downstream recycling processes (as shown in blocks 726-732) if the process 700 is used in combination with further recycling. For example, for synthetic fibres, including polyesters (such as PET) and polyamides, such downstream recycling processes may include one or more melt extrusion recycling processes (see block 732), whereby the textile polymers are melted under controlled conditions and re-spun into synthetic fibres or, alternatively, extruded into polymer pellets. For natural fibres such as cotton, such downstream recycling processes may include one or more mechanical recycling processes (see block 728), whereby the fibres are opened, carded, and re-spun into yarn. Additionally or alternatively, one or more further chemical processes (see block 730) may be used, such as where the cotton is subjected to a pre-treatment and used as cellulose source for regenerated cellulose, including man-made cellulosic (rayon) fibres. Other natural fibres such as wool can thereafter be mechanically recycled in a similar fashion to cotton.

In some embodiments of the process 700, the material is a polyester-elastane, polycotton-elastane, or cotton-elastane blended textile (in streams 111-1, 111-2, 111-3) of the wider modular recycling system, as received from Module A (110) after sorting. In some such embodiments, the ‘downstream recycling process’ are, for example, the module C and D for elastane-synthetic blended textiles, module F and E for polycotton-elastane blended textiles, and module F and G for cotton-elastane textiles. In some embodiments of the process 700, the material can also be a nylon-elastane blended textile of the wider modular recycling system, as received from Module A (110) after sorting, which would be fed into a separate downstream module homologous to modules C and D, but configured for polyamides or nylon instead.

### EXAMPLES

### Example 1—Removal of Elastane from Polyester-Elastane Blends with Cyclohexanone

In a 50 ml beaker, 25 ml of cyclohexanone is heated to 120° C. 1 g of an elastane and polyester blended textile (80% PET, 20% Elastane) is then charged into the beaker, and stirred with agitation for 10 minutes. This procedure is repeated 3 times and thereafter rinsed with a small portion of pure solvent. A solvent-exchange procedure with acetone is then performed, after which the residual acetone on the fabric is removed under reduced pressure. The resulting polyester fabric is thereafter determined to be free of elastane and soluble dyes by visual inspection, gel permeation chromatography, infra-red spectroscopy, and by measurement of the resulting mass loss.

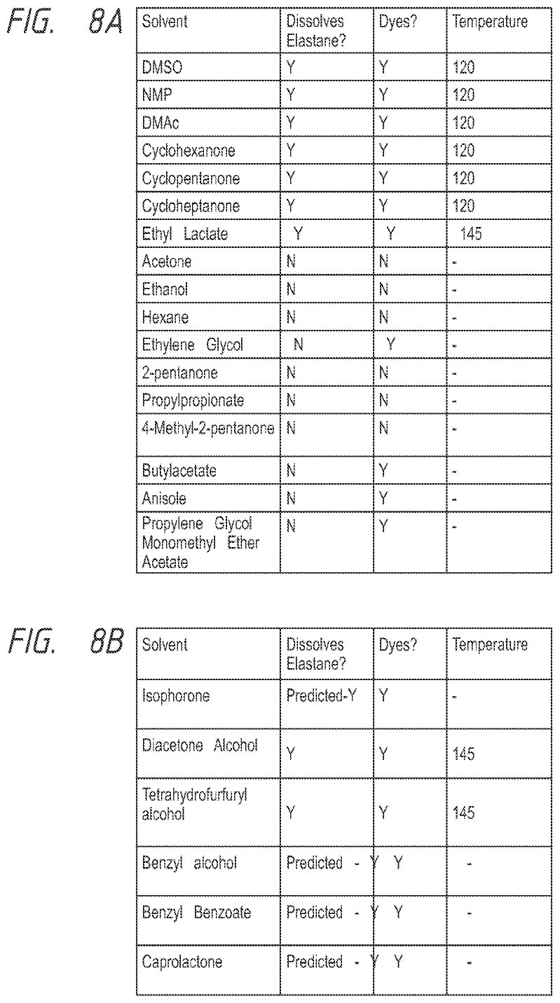

Testing was performed with various solvents using the same procedure as outlined in Example 1 above, to test for the ability of the selected solvent to dissolve Elastane from Polyester-Elastane blended textiles. The test results were fed into a prediction model based on solvent parameterisation and used to inform further solvent choices. Table 1 in FIG. 8A shows results from this solvent testing. Table 2 in FIG. 8B shows some possible solvents predicted by the solvent-parameterization model, but not tested, including two solvents, diacetone dialcohol and tetrahydrofurfuryl alcohol which were predicted by the model, and when tested, fully extracted elastane. Solvents with significant health risks such as chlorinated or certain phenolic solvents, or solvents with too high boiling points (>220° C.) were excluded.

### Example 2—Removal of Elastane from Polyester-Elastane Blends with Ethyl Lactate

In a 50 ml beaker, 25 ml of ethyl lactate is heated to 145° C. 1 g of an elastane and polyester blended textile (80% PET, 20% Elastane) is then charged into the beaker, and stirred with agitation for 10 minutes. This procedure is repeated 3 times and thereafter rinsed with a small portion of pure solvent. A solvent-exchange procedure with acetone is then performed, after which the residual acetone on the fabric is removed under reduced pressure. The resulting polyester fabric is thereafter determined to be free of elastane, solvent and soluble dyes by gel permeation chromatography, infra-red spectroscopy, and by measurement of the resulting mass loss.

### Example 3—Removal of Elastane from Cotton-Elastane Blends with Cyclohexanone

In a 50 ml beaker, 25 ml of cyclohexanone heated to 145° C. 1 g of an elastane and cotton blended textile (stretch blue denim 82% Cotton, 18% Elastane) is then charged into the beaker and stirred with agitation for 10 minutes. This procedure is repeated 3 times and thereafter rinsed with a small portion of pure solvent. A solvent-exchange procedure with acetone is then performed, after which the residual acetone on the fabric is removed under reduced pressure. The resulting cotton fabric is thereafter determined to be free of elastane and residual solvent by infra-red spectroscopy and by measurement of the resulting mass loss.

### Example 4—Extraction of Elastane from Polyester, Cotton and Elastane Blends with Cyclohexanone

In a 50 ml beaker, 25 ml of cyclohexanone is heated to 145° C. 1 g of an elastane and polycotton blended textile is then charged into the beaker and stirred with agitation for 10 minutes. This procedure is repeated 3 times. A solvent-exchange procedure with acetone is then performed, after which the residual acetone on the fabric is removed under reduced pressure. The resulting polyester and cotton blended fabric is thereafter determined to be free of elastane, solvent and soluble dyes by visual inspection, and by measurement of the resulting mass loss.

### Example 5—Extraction of Elastane from an Elastane and Nylon 6,6 Blend with Cyclohexanone

In a 50 ml beaker, 25 ml of cyclohexanone is heated to 145° C. 1 g of a nylon 6,6 and elastane blended textile is then charged into the beaker and stirred with agitation for 10 minutes. This procedure is repeated 3 times. A solvent-exchange procedure with acetone is then performed, after which the residual acetone on the fabric is removed under reduced pressure. The resulting nylon 6,6 fabric is thereafter determined to be free of elastane and solvent by visual inspection, and by measurement of the resulting mass loss.

With reference now also to FIG. 9, an example of a scale process for removing elastane from polyester prior to further recycling (e.g., via melt extrusion) is described. In this example, a solvent purification process according to the present disclosure is used to extract elastane from polyester and elastane blended textiles, to prepare it for a downstream melt recycling process. The process 900 starts by providing a fabric for purification. In one example, the fabric (or textile) waste may include a mixture of dispersed-dyed polyester (polyethylene terephthalate or PET) and elastane blended textile. The fabric is prepared for the purification process by shredding it to provide the fabric (or textile) feedstock at block 910. An organic solvent (see block 911) is heated to a target temperature and contacted (see block 912) with the fabric to substantially dissolve the elastane, soluble dyes (mainly disperse dyes), and other soluble organic and inorganic extractives. A variety of organic solvents may be used as is described herein. In one specific embodiment, the solvent is Cyclohexanone, which is heated to a target temperature of about 120° C. In other embodiments, cyclopentanone may be used.

The contacting can be performed in various ways in a scale application. For example, the contacting can be performed in a continuous fashion, such as by spraying or soaking the fabric feedstock as the fabric feedstock is advancing (e.g., on a conveyor) through the recycling system. In some embodiments, the feedstock may be portioned into batches, and each batch may be contacted with solvent (e.g., by immersion of the textile into the solvent) at least one time, and in some embodiments multiple (e.g., 2 or 3) times. In some such embodiments, each subsequent contacting step with a given batch may produce a progressively more dilute solution of elastane, dyes and contaminants in the solvent. Such more dilute solutions of the solvent from later contacting steps may be re-used in earlier contacting steps of the same or another batch, in some cases without first purifying the solvent. Reusing contaminated solvent in this manner may reduce the total volume of solvent utilized by the process. In some embodiments, the solvent may first be purified to remove the contaminants (e.g., the undesired polymer, dyes or other) before re-using it for textile purification at any step in the process. The step(s) of contacting the organic solvent with the fabric to extract undesired components may also be interchangeably referred to herein as “extraction” or “rinsing” steps, which may further involve the collection of contaminated solvent following the contact of the solvent with the fabric, also referred to herein as “separation” of the solvent from the solid form textile. Each immersion may be for a time of about 10 minutes to about 30 minutes. In some embodiments, the fabric is contacted with the solvent multiple times, including an initial, larger volume rinse step, followed by one or more (e.g., 2 or 3) additional smaller volume rinse steps. In some embodiments, the full batch of textile waste processed during the initial rinse step is rinsed, as a single batch, in the subsequent rinse steps, in some cases optionally with a smaller volume of solvent than in the initial rinse step. In other embodiments, the batch is further portioned into smaller sub-batches for the subsequent rinse steps, whereby a smaller volume of solvent may be used in the subsequent rinse steps than in the initial rinse step. The batch sizes may be determined such that the total usage of solvent, including the main extraction (or rinse) step, is not more than 15 times the mass of the dry textile, and preferably not more than 10 times the mass of the dry textile. In some embodiments, the subsequent rinse steps may take place using heated solvent (e.g., at the target temperature) or relatively cooler solvent (e.g., any temperature ranging from the target temperature to room temperature).

In some embodiments (e.g., when immersing the textile) the extraction may take place in a heated vessel, with horizontal or vertical agitation. In some embodiments, the solvent contacting is performed with a continuous flow of heated solvent, at a specific residence time and flow rate, until the depletion of the elastane. During the application of the heated solvent, the textile feedstock may be stationary, mobile, or a combination thereof (e.g., initially stationary and then advanced through the system as the contaminates are depleted, or the reverse whereby the feedstock is initially mobile and may be slowed down or stopped upon determination of slower than expected depletion of contaminants). The depletion of contaminants (e.g., elastane, dyes, etc.) form the textile may, for example, be detected in the solvent effluent, e.g., by spectroscopy, viscometry, or any other suitable method. The contaminant concentration in the solvent effluent may be provided to controller that controls the movement of the feedstock and/or the flow rate of the solvent at any stage of the path of the feedstock. In some embodiments, an augur-based counter-current extraction device may be used, whereby solvent moves counter to the fabric, at a specific residence time until the elastane is depleted. In other embodiments, the fabric is carried on a conveyor belt with spray of solvent, falling through a coarse filter on the conveyor based with gravity, at a specific speed and residence time until the elastane is depleted, by detection in the effluent with the above methods. In a variation of this embodiment, the conveyor belt system moves the fabric through the solvent whilst continuously immersing or partially immersing the fabric in the solvent. The fabric may additionally be contained on the conveyor in specific cells or baskets which are permeable to the solvent. In some embodiments, the containment cells or baskets include a permeable cover to contain the textile therein, such as during immersion steps.

In some embodiments, the dissolved elastane, dyes and other soluble contaminants are separated from the textile material in a solid-liquid separation process, for example via a course filter built into the extraction device at block 912, such that the majority of the elastane, dye and contaminants in solution drain and fall through the mass of textiles under gravity. Optionally, vacuum or compressive forces may be used to aid in solid-liquid separation. After removal of the elastane and other components the polyester is left undisturbed (at block 920), still in solid textile form, which is also referred to herein as substantially non-degraded. The polyester textile at block 920 may typically include a small amount (e.g., less than 5-10% of the applied solvent) of residual solvent soaked into the fabric. In block, 914, the solvent effluent from the extraction process of block 912 contains dissolved elastane, dyes and other soluble materials, and is sent, in the illustrated embodiment, for recovery of at least a portion of the organic dissolution solvent. The solvent may be recovered (at block 916) via any suitable means, in the illustrated example by distillation, leaving a solid waste containing elastane and dyes (see block 917). This solid waste can be used for energy recovery by incineration (see block 918).

In some embodiments, further recovery of additional solvent occurs through recovery of the residual solvent on the polyester textile (see block 922). In the illustrated example, residual solvent is first removed by a physical pressing action using e.g., compressive, vacuum, or centrifugal forces. This physical pressing removes substantially all remaining excess solvent from the shredded textile material. Various types of equipment can be used for the pressing, such as, but not limited to, a graduated augur press, a screw press, a roller press, a hydraulic or pneumatic filter press, or centrifuge. In block 924 of the illustrated embodiment, any remaining residual solvent is removed from the textile by the application of heat, optionally aided by either vacuum or a positive airflow over the material. The textile may be heated to slightly over the boiling point of the solvent (e.g., 160° C. for Cyclohexanone used in this example), after which textile, dry and free of solvent, may be provided to downstream recycling processes. In other embodiments, cyclopentanone may be used. The heating may take place at the same location (e.g., in the same vessel) as in steps 912 or 922. The residual solvent collected at steps 922 and/or steps 924 may be recycled into the system (at block 910). As shown in block 930, after solvent removal, the polyester textile (e.g., PET) material can optionally be subjected to a solid or liquid-state polymerisation process. As further shown in block 932, the resulting polyester in solid or melt form can then be processed into polyester filament yarn as shown in block 934, such as via melt-extrusion to a filament or staple yarn, or into polymer pellets, which can then be processed into yarns in downstream facilities. It is understood that individual process steps may be operated as separate process steps or combined into process steps as needed, depending on the specific process equipment. In a further embodiment, the PET and elastane blend can instead be a Polyamide and Elastane blend under the same conditions. In a further embodiment, the PET and elastane blend can instead be a PET, Cotton and Elastane blend, where the temperature is not more than 150° C., and where the PET and Cotton material is fed into the poly-cotton separation process after step 912, with the purified PET component after the blend separation proceeding to block 920. In this embodiment, the pre-treatment process described for poly-cotton separation may take place prior to the unwanted polymer (i.e. elastane) removal in the preferred embodiment. In a further embodiment, the PET and elastane blend can instead be a Cotton and Elastane blend, where the temperature is between 145-155° C.

Cellulose Recycling Process

In accordance with further examples of the present disclosure, solvent with an ionic additive may be used for dissolving and removing cellulose from cellulose-containing textile waste materials (e.g., a feedstock of pre- or post-consumer textiles or other textile waste). Referring to FIGS. 10A and 10B, the cellulose extraction process 1000 starts by providing a feedstock of textile material, as shown in step 1010. In this example, the feedstock is a cellulose-containing textile material, from either pre-consumer or post-consumer sources. In one specific embodiment, this cellulose-containing textile material comprises a polyester-cotton blended textile material in any proportion. In another embodiment, the cellulose-containing textile material may be a cotton textile material. In other embodiments, the cellulose component can be other cellulosic natural fibres, including hemp, linen, rayon (such as viscose or lyocell) or any combination thereof with synthetic fibres. In other embodiments, the cellulose-containing textile material can include a mixture of any synthetic fibre e.g., a polyamide (PA 6, PA 6,6, PA 6,10, PA 11, PA10,10 or similar) and cellulose-based fibre textile material. In some embodiments, the cellulose extraction process 1000 described here can be used to implement, at least partially, the modules E (116), F (120) and G (122) of the system 100 described above with reference to FIG. 1. In some embodiments of the process, the cellulose-containing material can be pure-cotton textile (stream 111-2), as received from Module A (110) after sorting, or from Module B after removal of elastane and thus represents an embodiment of Modules F (120) and G (122). In some embodiments of the process, the cellulose-containing material is a polyester and cotton blend “polycotton” (stream 111-3) which is received from the sorting Module A (110), and thus represents an embodiment of Modules E (116), F (120) and G (122). The cellulose dissolution, extraction and regeneration process as whole thus represents the key embodiment of both modules E, F and G (116, 120 and 122), depending on the input material.

In some embodiments, as shown in step 1012, the cellulose-containing textile material can optionally be subjected to a pre-treatment process to prepare the cellulose contained within the material for dissolution. Any suitable known process for pre-treatment of the cellulose for cellulose dissolution may be used. In some embodiments, the pre-treatment step 1012 may implement Module F of the modular recycling system described above. The cellulose pre-treatment module F of the recycling system may be implemented, additionally or alternatively, using other processes that tailor various properties of the cellulose-containing material (i.e. cotton-containing textiles). In the present example, the pre-treatment process may be configured such that it primarily targets the reduction in molecular weight of the material. However, this does not exclude the potential use of other pre-treatments steps for the cellulose material, as described herein. For example, in this embodiment, the pre-treatment process (step 1012) may include any suitable acid hydrolysis or enzymatic hydrolysis process that reduce the molecular weight of cotton. In one embodiment, the cellulose-containing textile material is treated with a dilute acidic aqueous solution, e.g., in a range from 0.05-2 M including dilute H₂SO₄ and HCl, at a temperature between 50° C. and 100° C. for up to 2 hours. In some embodiments, an acid hydrolysis pretreatment process may take place in the presence of the organic solvent medium introduced at step 1014 described further below.

In step 1014, a co-solvent component is introduced to the cellulose-containing material. In some embodiments, this can be the same organic solvent as described previously for unwanted polymer removal from a textile material. For example, suitable solvents for introduction at step 1014 may include, but are not limited to, cyclic ketones of a general structure (CH₂)ₙCO where n=3,5,6,7), alkyl esters (including methyl and ethyl lactate), acetone, tetrahydrofurfuryl alcohol and diacetone alcohol, or aprotic solvents including dimethylsulfoxide, N-Methyl-2-pyrrolidone, dimethylacetamide and dimethyl formamide. In some such embodiments, in lieu of step 1014 and before step 1016, a polymer purification process according to any of the examples herein (e.g., process 700 or 900) can take place. In another embodiment, the co-solvent can be water. If a pretreatment step is applied prior to step 1014 (e.g., pre-treatment process 1012), the pre-treatment medium is washed off, for example with a combination of the original solvent (e.g., water) followed by the solvent medium for step 1014 (e.g., the organic solvent of any of the examples herein), with the resulting solvent mixture being recovered by distillation or another appropriate method.

Notably, in some embodiments, the same solvent that is used to remove elastane and polyurethanes, dyes and other impurities in the aforementioned embodiment of Module B (112) the polymer purification process, can also be used as the organic co-solvent component of the cellulose-dissolving mixture. This brings additional benefits: a reduction in cost and complexity, but also the ability to directly integrate the cellulose-dissolution and polycotton separation process into the previously described polymer purification process. Material (including polycotton blends and cotton textiles blended with elastane) can be received from the polymer purification process with their elastane and dyes removed. This is thereafter no need to remove the solvent (which would expend additional energy), as it forms a crucial component of the cellulose-dissolving mixture. Thus from the modular system, through the cellulose recycling process described here, we can produce cellulose materials including fibres, from mixed textile materials also containing polymers such as elastane.

At step 1016, an ionic component is added to the cellulose-containing material and molecular solvent mixture. In preferred embodiments, the ionic component is selected such that when combined with the molecular co-solvent component, at any concentration, the hydrogen-bond basicity, hydrogen-bond acidity and solvent polarity of the mixture fall within the range required to dissolve the cellulose component (e.g., as measured, for example, by a solvo-chromatic technique, such as Kamlet-Taft). In some embodiments, ionic components having high hydrogen-bond Kamlet-Taft basicity (>0.8β), a low hydrogen-bond acidity (<0.8α) and high solvent polarizability (>0.8π) are used. Molecular co-solvent components can be selected such that their hydrogen-bond acidity is low, between (0-0.2α), and that when mixed with the ionic component, the mixture has a high basicity, ideally (>1β), low hydrogen-bond acidity, ideally (<0.5α) and a net-basicity (β-α of between 0.3-1).

In some embodiments, the ionic component may be Alkyl Phosphonium or alkyl ammonium (‘onium’) salts of the general structure PR₄+ or NR₄+ where R is an aliphatic alkyl chain with carbon chain length from 1-14 or a benzyl group in any combination, and where the anion is a carboxylate (preferably acetate, or alternatively any carboxylate with the general structure RCOO— where R is an aliphatic alkyl chain with a carbon chain length from 1-14) in any combination; a halide (including chloride or bromide); or hydroxide. In some examples, the ionic component may be Alkyl Imidazolium cations of the general structure shown in FIG. 11, where R can be an aliphatic chain with carbon chain length from 1-14 coupled with an anion, which can be a carboxylate (preferably acetate, or alternatively any carboxylate with the general structure RCOO— where R is an aliphatic alkyl chain with a carbon chain length from 1-14); a halide (including chloride or bromide); or hydroxide. The examples above are illustrative only and do not limit the scope of the possible combinations. Salts of various other suitable combinations, and other moieties or structures may be used in other embodiments.

Particularly, blends of ionic liquids of the aforementioned structural homologues and other ionic liquids, in combination with cyclic ketones of a general structure (CH₂)ₙCO where n=3,5,6,7), alkyl esters (including methyl and ethyl lactate) and certain solvents including acetone, tetrahydrofurfuryl alcohol and diacetone alcohol, are novel and not known for the dissolution of cellulose, outside the context of textile recycling and polycotton separation. In particular, the ability of some cyclic ketones such as cyclopentanone offer a key novelty in that they can be recovered after the regeneration of cellulose with a water-based anti-solvent via phase-separation, as described further below.

In other embodiments, the molecular co-solvent component and the ionic additive can be mixed separately and/or prior to the introduction of the textile cellulose-containing material.

The mixture of a molecular co-solvent and the ionic additive, in proportions that enable the dissolution and extraction of cellulose from cellulose-containing materials such as polycotton textiles, entails numerous benefits than either component alone. This includes a general reduction in cost, as the molecular solvents are typically cheaper to manufacture, a reduction in viscosity, which enables easier mixing and mass transport, and an associated reduction in energy usage, as well as the ability to dissolve and extract cellulose from the blends at lower temperatures than might otherwise be possible, without the molecular solvent component. This additionally allows for the possibility to substantially avoid any potential degradation of the synthetic component (i.e. polyesters e.g. PET or polyamide) in cellulose-containing blends. Without the ionic additive, the molecular solvent components do not have the required properties on their own (hydrogen bond basicity) to dissolve and extraction cellulose, enabling, for example, polycotton separation.

In an exemplary embodiment, dissolution times can be in the range from about 0.5-5 hours, at a temperature ranging from room temperature to about 120° C. In a preferred embodiment, the dissolution occurs at a temperature of about 100° C. or less, with time and temperature controlled such that degradation of the synthetic polymer (e.g., in the embodiment containing a polycotton blended textile) is minimised and in the absence of impurities which may degrade the synthetic polymer component. In exemplary embodiments, concentration of the ionic component can be between 5 and 95 wt %, and preferably between 5 and 50 wt %. In some embodiments, as shown at optional step 1018, the cellulose-containing material can be subjected to a second (and/or third, etc.) dissolution stage(s), such that any remaining cellulose is fully removed. In some embodiments, the more dilute solution from the subsequent (downstream) dissolution stages is used as the dissolution medium in preceding dissolution stages. For example, the relatively more dilute solution from a third dissolution state may be used in the second dissolution stage, and/or the solution from the second dissolution may be used as the dissolution medium for the first dissolution stage.

As shown in step 1020 in FIG. 10B, the residual solvent mixture is removed from the residual material. This can include rinsing with the co-solvent component utilised in step 1014, in which case the dilute residual solvent can be recovered together in the solvent recovery process 1022. In step 1024, the residue is dried for downstream use. This may take place in the drying stage as described in the process for removal of unwanted polymers from a textile material. Optionally, in one embodiment the solvent can be exchanged with a second, lower boiling point solvent such as ethanol, methanol, acetone or similar. The dry residue (see 1026) is then ready for further downstream recycling. In the embodiment where the cellulose-containing material is a polycotton blended textile, the residue is a synthetic polyester (including PET, PTT, PBT and others) textile material. This can then be recycled via melt-extrusion to a yarn or via other external processes, such as chemical recycling. In another embodiment, this synthetic textile residue can be nylon or polyamide (PA 6, PA 6,6, PA 6,10, PA 11, PA10,10 or similar). For blended cellulose-containing materials, after the process, the dry residue is substantially still in a textile form, with the cellulose portion removed. This can, for example, be a polycotton blended textile, leaving a polyester textile residue, without the cotton portion. This forms a key novelty of the process, as the remaining polyester textile material can then be used in melt-recycling, as described in the modular textile recycling process (module C (114) and D (118)) as it is itself not dissolved, degraded, or decomposed into its molecular components. Where the cellulose containing material, is, for example, a 100% cotton textile (with the elastane or other contaminants removed) the material is fully dissolved, leaving no dry residue. In these embodiments, steps 1020, 1024, and 1026 are not required.

Referring back to FIG. 10A, in step 1015, the dissolved cellulose in solution is separated from the residue (e.g., a synthetic fibre material such as a polyester or polyamide), for example, by filtration. Optionally, the filtration may be aided by vacuum or via the application of force, i.e. press filtration. In step 1017, the dissolved cellulose in solution is then free of the residue material, and proceeds to optional step 1019, whilst the residual material after dissolution proceeds to step 1020. In some embodiments, it may be beneficial for downstream fibre spinning applications to increase the concentration of cellulose in the solution (via optional step 1019), for example by evaporation of the more volatile co-solvent component introduced in step 1014. This evaporation may include the application of heat, in some cases agitation, and optionally vacuum. The volatile co-solvent component is thereafter recycled for use in step 1014. In such cases, the starting concentration of the solution is anywhere between 0.1-5 wt % and the end solution strength is in the range 10-20 wt %. The cellulose from step 1017 and optional step 1019 is provided to a regeneration process (step 1030), where an anti-solvent regeneration medium is used to precipitate cellulose (regeneration) from the dissolved cellulose in solution. In some embodiments, this anti-solvent regeneration medium is water-based (aqueous). In some embodiments, the anti-solvent regeneration medium contains only water, but optionally a range of inorganic salts may be added, which may improve either phase-separation or tailor the resulting fibres physical properties. Optionally, salts can be added to the aqueous medium to improve cellulose regeneration properties and/or phase separation. This can include a cation selected from: Na, K, Li, Zn, and anion selected from OAc, SO₄, Cl, OH, CO₃, or any carboxylate with the general structure RCOO— where R is an aliphatic alkyl chain with a carbon chain length from 1-14) or alternatively acids including sulphuric acid, H₂SO₄, HCl, or others.

Following the cellulose regeneration process 1030, a shaped cellulose article, made from regenerated cellulose, is produced at step 1032. In some embodiments, the output (at step 1032) is a regenerated cellulose fibre or yarn, spun with a dry-jet wet spinning method into an aqueous-based spinning bath. In some embodiments, this can be any articles such as films or composite materials which are formed primarily of regenerated cellulose via precipitation with an anti-solvent, such as water. In some embodiments, after the cellulose article (e.g., fibre) is regenerated at step 1032, the aqueous anti-solvent regeneration medium and cellulose-dissolving solvent mixture from the preceding steps are mixed together at this stage (see 1034) and it may be advantageous to separate them, to be recovered for reuse.

In some examples, the anti-solvent and cellulose-dissolving solvent mixture can be recovered via a solvent-recovery process (at step 1022). In one embodiment, the co-solvent component introduced in step 1014 is hydrophobic, having a limited solubility in water. In particular, cyclopentanone and other cyclic ketones can form phase-separable mixtures with the ionic additive and water. In particular, these specific solvents can also be used in the aforementioned polymer purification process to remove elastane and other impurities, allowing for further synergies between the processes, enabling a reduction in cost and energy expenditure. In some such embodiments, the solvent recovery process at step 1022 can therefore include at least 1 phase-separation stage. Phase-separation of the cellulose-solvent from an aqueous anti-solvent leads to lower energy usage in the solvent recovery process due to the avoidance of at least one distillation operation, which is favourable for both the economics and sustainability of the process. In the phase-separation pathway, the organic solvent and the ionic additive form the organic phase and the aqueous anti-solvent the aqueous phase. In the illustrated embodiment, after phase-separation, the separated aqueous phase is recycled such that it is used as the anti-solvent for cellulose regeneration again in step 1030. In further embodiments, this aqueous phase may contain small amounts of the cellulose-dissolving solvent (co-solvent and ionic-additive) remaining after phase-separation, with minimal effect on its usefulness as an anti-solvent for cellulose regeneration. After phase-separation, the organic phase containing the organic solvent and ionic additive may be completely separated thereafter by distillation and the separated components recycled for use in the process. In other embodiments, the combined organic phase is stripped of water, for example, with molecular sieves, and re-used directly as the cellulose-dissolving medium in steps 1018 and 1020. Although representative examples are given, the phase-separation process may proceed with a range of potential other ionic additives, given they meet the criteria for cellulose dissolution with the organic solvent component. In some embodiments, in which the co-solvent component is an organic solvent, the cellulose-dissolving mixture and water may be separated purely by a distillation process, such as fractional distillation. In some embodiments of the process, the cellulose-containing material can be pure-cotton textile (stream 111-2), as received from Module A (110) after sorting, or from Module B after removal of elastane and thus represents an embodiment of Modules F (120) and G (122). In some embodiments of the process, the cellulose-containing material is a polyester and cotton blend “polycotton” (stream 111-3) which is received from the sorting Module A (110), and thus represents an embodiment of Modules E (116), F (120) and G (122)

### EXAMPLES

### Example 1—Extraction of Cellulose with a Tetrabutylphosphonium Hydroxide (Aq) Solution

5-cm×5-cm swatches of a 57% Cellulose 43% PET fabric were fully immersed in a 0.3M sulfuric acid solution at 90° C. for 45 minutes. After treatment the acidic water was poured off and neutralized before disposal. Distilled water was used to rinse the fabric. Swatches were rinsed individually dried over a Buchner funnel and solvent-exchanged with acetone and dried at room temperature. The fabric swatches were then immersed in a 40% solution of tetrabutylphosphonium hydroxide (TBPH (aq)) at 60° C. for 3 hours, after which the residual fabric was removed and placed in a second TBPH (aq) solution for 1 hour. After the second dissolution, the residual fabric is rinsed with water, solvent exchanged with acetone and dried for further use

### Example 2—Extraction of Cellulose with a 1-Butyl-3-methylimidazolium acetate (BMIMA)/cyclopentanone solution

5-cm×5-cm swatches of a 57% Cellulose 43% PET fabric were fully immersed in a 0.3M sulfuric acid solution at 90° C. for 45 minutes. After treatment the acidic water was poured off and neutralized before disposal. Distilled water was used to rinse the fabric. Swatches were rinsed individually dried over a Buchner funnel and solvent-exchanged with acetone and dried at room temperature. The fabric swatches were then immersed in a BMIMA/cyclopentanone (0.3:0.7 mol) solution at 100° C. for 3 hours, after which the residual fabric was removed and placed in a second BMIMA/cyclopentanone solution for 1 hour. After the second dissolution, the residual fabric is rinsed with water, solvent exchanged with acetone and dried for further use.

### Example 3—Extraction of Cellulose with a 1-Butyl-3-Methylimidazolium Acetate (BMIMA)/DMSO Solution

5-cm×5-cm swatches of a 57% Cellulose 43% PET fabric were fully immersed in a 0.3M sulfuric acid solution at 90° C. for 45 minutes. After treatment the acidic water was poured off and neutralized before disposal. Distilled water was used to rinse the fabric. Swatches were rinsed individually dried over a Buchner funnel and solvent-exchanged with acetone and dried at room temperature. The fabric swatches were then immersed in a BMIMA/DMSO (0.3:0.7 mol) solution at 100° C. for 3 hours, after which the residual fabric was removed and placed in a second BMIMA/DMSO solution for 1 hour. After the second dissolution, the residual fabric is rinsed with water, solvent exchanged with acetone and dried for further use.

### Example 4—Phase-Separability and Phase Diagram of Cyclopentanone, BMIMA, and Water and Other Co-Solvent-Ionic Additive Mixtures

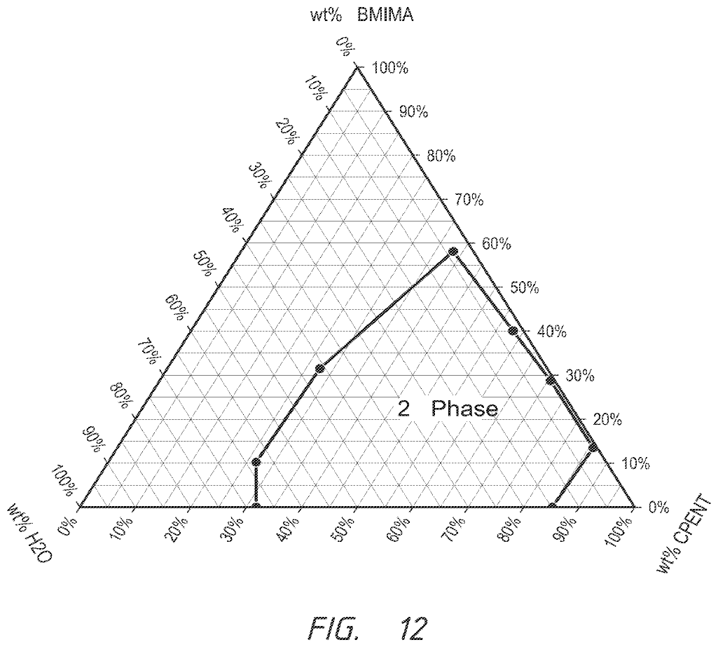

To demonstrate the phase-separability of an example cellulose-dissolving mixture for easier recovery from water, as a cellulose anti-solvent and regeneration medium, a binodal curve showing the 1-phase and 2-phase region of the ternary mixtures were constructed. To recover the ionic component and the organic solvent component by phase separation, water must be added thus that the composition of the medium is within the 2-phase region. Mixtures of the 3 components (e.g. Cyclopentanone, BMIMA, Water) were prepared, and the third component added, with stirring, at room temperature until the cloud point was determined visually. An example ternary diagram is presented in FIG. 12. Ternary mixtures with other cellulose dissolving mixtures, including EMIMA (1-ethyl-3-methylimidazolium acetate), P4444A (tetrabutylammonium acetate) and N4444A (tetrabutylphosphonium acetate) also results in phase-diagrams with a similar shape and area. A large 2 phase region is found, which corresponds to known cellulose-dissolving compositions of the solvents, after the addition of water as a cellulose anti-solvent and regeneration medium.

### Example 5—Expanded Screening of Cellulose-Dissolving Mixtures with Elastane-Dissolving Co-Solvents and Representative Ionic Additives

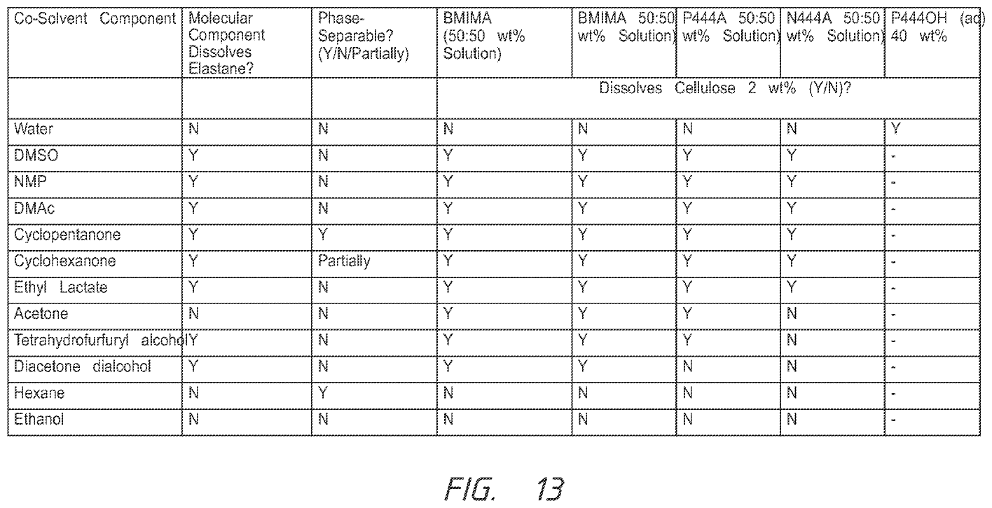

Only certain combinations of molecular co-solvent and ionic additive can dissolve cellulose, thus enabling the separation of polycotton fabrics via the dissolution of the cellulose component. In this experiment, we screened potential candidate solvent mixtures, some of which are solvents known to dissolve elastane in our previously described polymer purification process. A 50:50 wt % mixture of the co-solvent molecular component, along with a range of ionic components—which exemplify the range of potential structural homologues that can be used, were prepared. ca. 2 wt % of a cellulose model compound (that matches the molecular weight of the material after pre-treatment) which was dissolved in the mixtures at a temperature of 100° C., whereby the dissolution was tracked visually. Solutions which were optically clear, viscous, and free of fibres were classed as dissolved. The results are reported in the table shown in FIG. 13, along with the previously reported ability of the molecular co-solvent component to dissolve and extract elastane, and the phase-separability of the combined mixtures, as determined by the above procedure. BMIMA (1-Butyl-3-methylimidazolium acetate), EMIMA (1-ethyl-3-methylimidazolium acetate), P4444A (tetrabutylammonium acetate) and N4444A (tetrabutylphosphonium acetate were screened.

### Example 6—Exemplification of Cellulose Regeneration from Dissolved Cotton Cellulose in a 1-Butyl-3-Methylimidazolium Acetate/Cyclopentanone Solution

Cellulose may be regenerated from the dissolved solutions after extraction in a variety of forms. To do this, an anti-solvent, typically water, is introduced. In the case of fibre spinning, for example, the solution is extruded into a water bath. A previously pre-treated, dissolved and heated solution of cellulose (ca. 100° C.), from cotton, in 1-Butyl-3-methylimidazolium acetate/cyclopentanone (50:50 wt % solution) was poured into a large excess of RI water, with stirring, for one hour. The regenerated cellulose was washed ×3 with RI water and ×3 with acetone and dried over vacuum. The yield of recovered cellulose was approximately 96% by weight.

The foregoing description has broad application. The discussion of any embodiment is meant only to be explanatory and is not intended to suggest that the scope of the disclosure, including the claims, is limited to these examples. In other words, while illustrative embodiments of the disclosure have been described in detail herein, the inventive concepts may be otherwise variously embodied and employed, and the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

What is claimed is:

1. A method comprising:
a) providing a feedstock of a blended textile material or a mixture of textile materials comprising at least one target polymer together with an undesired polymer and an organic solvent having a boiling point below a melting point of the at least one target polymer;
b) heating the organic solvent to a target temperature ranging from about 60° C. to about 200° C.;
c) contacting the organic solvent with the blended textile material or mixture of textile materials for a period of time not exceeding 90 minutes to dissolve the undesired polymer in the organic solvent, without dissolving the at least one target polymer, thereby providing 1) a solvent solution comprising the dissolved undesired polymer, and 2) a purified textile material substantially free of the undesired polymer; and
d) separating the solvent solution comprising the dissolved undesired polymer from the purified textile material.

2. The method of claim 1, wherein the organic solvent is heated to the target temperature prior to said contacting the organic solvent with the blended textile material or mixture of textile materials.

3. The method of claim 1, wherein the organic solvent is heated to a temperature of at least 120° C.

4. The method of claim 3, wherein the organic solvent is heated to a temperature of at least 145° C.

5. The method of claim 1, wherein the organic solvent is selected from the group consisting of aprotic solvents, bio-based alkyl esters, cyclic ketones having a general structure (CH₂)ₙCO, wherein n is equal to 4, 5, 6 or 7, diacetone dialcohol, and tetrahydrofurfural alcohol.

6. The method of claim 5, wherein the organic solvent is an aprotic solvent selected from the group of dimethylsulfoxide, N-Methyl-2-pyrrolidone, dimethylacetamide, dimethyl formamide.

7. The method of claim 1, wherein the at least one target polymer comprises at least one of a Polyester polymer, a Polyamide polymer, a Cellulose polymer, or a combination thereof.

8. The method of any of claims 1-7, wherein the undesired polymer is a polyurethane, wherein optionally preferably the polyurethane is elastane.

9. The method of any of claims 1-7 further comprising providing the purified textile material to one or more downstream recycling processes via which a new PET fibre or cellulose fibre is created from the purified textile material.

10. The method of claim 7, wherein the at least one target polymer comprises cellulose and the organic solvent is cyclohexanone.

11. The method of claim 1, wherein the at least one target polymer comprises polyester and the organic solvent is selected from cyclopentanone, cyclohexanone and ethyl lactate.

12. The method of claim 11, wherein the at least one target polymer further comprises cellulose, whereby the purified textile material comprises polyester and cellulose.

13. The method of claim 12 further comprising:
e) contacting the purified textile material with a mixture including the organic solvent and an ionic additive to dissolve the cellulose from the purified textile material.

14. The method of claim 1 or 13 further comprising recovering at least a portion of the organic solvent from the contaminated solvent solution and re-using the recovered organic solvent at steps (b), (c) or (e) of the method.

15. The method of claim 14, wherein said re-using the recovered organic solvent comprises providing at least a portion of the organic solvent recovered following a preceding contacting step to a downstream contacting step of the method.

16. The method of claim 1, wherein said contacting the organic solvent with the blended textile material or mixture of textile materials comprises at least one of immersing the blended textile material or mixture of textile materials in a vat containing the solvent, and spraying the blended textile material or mixture of textile materials with the solvent.

17. The method of claim 16, wherein the blended textile material or mixture of textile materials is transported on a conveyor belt during said contacting with the organic solvent.

18. The method of claim 17, wherein said contacting comprises passing the blended textile material or mixture of textile materials through a substantially continuous stream of the organic solvent as the blended textile material or mixture of textile materials is being transported on the conveyor belt.

19. The method of claim 1 further comprising agitating the blended textile material or mixture of textile materials while in contact with the organic solvent.

20. The method of claim 1, wherein said contacting provides a solvent-wetted textile material and wherein said separating the contaminated solvent solution comprises applying a force on the solvent-wetted textile material to remove at least a portion of the contaminated solvent solution therefrom.

21. The method of claim 20 further comprising evaporating residual organic solvent from the solvent-wetted textile fabric.

22. The method of claim 20 further comprising removing residual organic solvent from the solvent-wetted textile fabric via a solvent exchange with a second solvent having a boiling point lower than the boiling point of the organic solvent.

23. The method of claim 22 wherein the second solvent is selected from methanol, ethanol, acetone, or a combination thereof.

24. A method comprising:
a) providing a feedstock of a textile material comprising cellulose and at least one other polymer;
b) applying an organic co-solvent and an ionic component to the textile material to dissolve at least a portion of the cellulose from the textile material and produce a cellulose-containing solution, wherein the co-solvent has a boiling point below a melting point of the at least one other polymer, and wherein the ionic component has hydrogen-bond Kamlet-Taft basicity above 0.8β, hydrogen-bond acidity below 0.8α, and solvent polarity above 0.8 π;
d) separating the cellulose-containing solution from the textile material; and
e) using water or water-based anti-solvent regeneration medium to precipitate the cellulose from the cellulose-containing solution for subsequent use in regenerated cellulose fibers.

25. A method comprising:
a) providing a feedstock of a cellulose-containing textile material together with an organic co-solvent to produce a cellulose-containing material and molecular solvent mixture;
c) adding an ionic component to the mixture to dissolve at least a portion of the cellulose from the cellulose-containing textile material and produce a cellulose-containing solution, wherein the ionic component has hydrogen-bond Kamlet-Taft basicity above 0.8β, hydrogen-bond acidity below 0.8α, and solvent polarity above 0.8 π;
d) separating a residual material from the cellulose-containing solution; and
e) using water or water-based anti-solvent regeneration medium to regenerate the cellulose from the cellulose-containing solution.

26. The method of claim 25, wherein the cellulose-containing textile material comprises a polyester-cotton blended textile material, a cotton textile material, a blended material comprising synthetic fibers in combination with cellulosic natural fibers selected from hemp and other cellulose-based bast or leaf fibres, linen, rayon, a mixture of polyamide fibers and cellulose-based fibers, or any combinations thereof.

27. The method of any of claims 24-26, wherein the co-solvent is an aprotic solvent, a bio-based alkyl ester, or a cyclic ketone having a general structure (CH₂)ₙCO, wherein n is equal to 4, 5, 6 or 7, as well as acetone, diacetone dialcohol and tetrahydrofurfural alcohol, and wherein optionally preferably the aprotic solvent is selected from the group consisting of: dimethylsulfoxide, N-Methyl-2-pyrrolidone, dimethylacetamide, and dimethyl formamide.

28. The method of any of claims 24-26, wherein the ionic component comprises Alkyl Phosphonium or Alkyl Ammonium salts having a general structure PR 4+ or NR 4+, wherein R is an aliphatic alkyl chain with carbon chain length from 1-14 or a benzyl group, coupled with an anion, and wherein optionally preferably the anion is a carboxylate, a halide, or a hydroxide.

29. The method of any of claims 24-26, wherein the ionic component comprises Alkyl Imidazolium cations having a general structure (IUPAC: 3-R-1-R-3H-imidazol-1-ium+), wherein R is an aliphatic chain with carbon chain length from 1-14, coupled with an anion, and wherein optionally preferably the anion is a carboxylate, a halide, or a hydroxide.

30. The method of claim any of claims 24-26 further comprising pre-treating the textile material using an acid hydrolysis or enzymatic hydrolysis process that reduces the molecular weight of cotton.

31. The method of any of claims 25-26, wherein the cellulose-containing material is composed of dissolving pulp or cotton linters, optionally in any proportion with a cellulose-containing textile material, and wherein the co-solvent is a bio-based alkyl ester, or a cyclic ketone having a general structure (CH2)nCO, wherein n is equal to 4, 5, 6 or 7, as well as acetone, diacetone dialcohol and tetrahydrofurfural alcohol, and wherein optionally preferably there is minimal to no residual material.

32. A method of recycling textile waste, the method comprising:
receiving, in the recycling system, a feedstock of textile waste, wherein the textile waste comprises shredded mixed composition textile material comprising one or more target polymers and one or more undesired polymers;
conveying at least a portion of the textile waste along a travel path of the recycling system and through a textile purification process, wherein the textile purification process comprises applying an organic solvent to the textile waste in at least one solvent rinsing stages to separate the one or more undesired polymers from the one or more target polymers, wherein the organic solvent has a boiling point below a melting point of the at least one target polymer; and wherein organic solvent from a subsequent rinsing stage along the travel path is recycled into a preceding rinsing stage, following purification of the organic solvent from the subsequent rinsing stage.

33. The method of claim 32, wherein the organic solvent is an aprotic solvent, a bio-based alkyl ester, or a cyclic ketone having a general structure (CH₂)ₙCO as well as diacetone dialcohol and tetrahydrofurfural alcohol, wherein n is equal to 4, 5, 6 or 7, and wherein optionally the aprotic solvent is selected from the group consisting of: dimethylsulfoxide, N-Methyl-2-pyrrolidone, dimethylacetamide, and dimethyl formamide.

34. The method of claim 32, wherein the one or more undesired polymers are separated from the one or more target polymers without degrading the textile material.

35. The method of claim 32, wherein the one or more target polymers include a polyester and cellulose, the method further comprising applying a mixture of the organic solvent and an ionic additive to a purified textile material comprising the polyester and cellulose to dissolve at least a portion of the cellulose from the textile material, and providing the dissolved cellulose to one or more further recycling processes for generating new cellulose-containing fibers.

36. A portable system for recycling textile waste, the system comprising:
a sorting module configured to receive a single input stream of mixed composition textiles, shred the mixed composition textiles into shredded textile waste, and autonomously sort the shredded textile waste into a plurality of output streams of shredded textile waste substantially devoid of non-textile materials such that a first output stream of shredded textile waste contains substantially only blends of polyester material and one or more other non-polyester materials, and a second output stream of shredded textile waste contains substantially only cellulose-based materials; and
a conveyor system configured to supply each of the plurality of output streams to a respective one of a plurality of textile waste processing paths, each configured to process the textile waste using a different process, wherein the plurality of textile waste processing paths includes:
a first processing path that receives the first output stream of shredded textile waste and separates, using a first solvent, the polyester material from the non-polyester materials without decomposing or dissolving the polyester material; and
a second processing path that receives at least one of the second output stream of shredded textile waste and cellulose-based materials output by the first processing path, and is configured to remove dyes from the cellulose-based materials and output cellulose having a reduced molecular weight.

37. The system of claim 36, wherein the sorting module is configured to clean the mixed composition textiles, prior to shredding, using a non-toxic drycleaning solvent.

38. The system of claim 36, wherein the sorting module comprises:
a camera arranged to have an upstream segment of the conveyor system that supports the shredded textile waste in its field of view;
a processor in communication with the camera and configured to execute a machine-learning model trained to identify different fabric compositions in images of shredded textile waste; and
a robotic arm responsive to the processor and arranged to move a first portion of the shredded textile waste having a fabric composition different from other shredded textile waste to a first portion of a downstream segment of the conveyor system for diverting shredded textile waste having different fabric composition to different ones of the plurality of textile waste processing paths.

39. The system of any of claim 36, wherein the sorting module is configured, after shredding the textile into shredded textile waste, to separate non-textile materials from the shredded textile waste by at least one of density, magnetic demetaling, and/or eddy current non ferrous ejection.

40. The system of claim 39, wherein the sorting module includes a density sorting unit comprising:
first and second conveyor belt portions, wherein the first conveyor belt portion is configured to spread the shredded textile waste along its travel direction, and wherein the second conveyor belt portion is spaced from the first conveyor belt portion by a gap;
an air pump arranged to supply airflow at the gap to at least partially support the shredded textile waste, via air pressure acting in a direction against gravity, while the shredded textile passes across the gap between the first and second conveyor belt portion.

41. The system of any of claim 36, wherein the first processing path includes a polyester separation module configured to receive the first output stream as input, apply the first solvent to the input in a continuous solvent extraction process, and output a substantially pure PET textile.

42. The system of claim 41, wherein the first solvent is selected from the group consisting of aprotic solvents, bio-based alkyl esters, cyclic ketones having a general structure (CH₂)ₙCO, wherein n is equal to 4, 5, 6 or 7, diacetone dialcohol, and tetrahydrofurfural alcohol.

43. The system of claim 41, wherein the first solvent has a boiling point within 20-30 degree Celsius range of its solvent stripping point.

44. The system of claim 41, wherein the continuous solvent extraction process comprises:
soaking the input with the first solvent to produce solvent-wet PET textile and heating the solvent and/or the solvent-wet PET textile to a temperature not exceeding 150 degrees Celsius;
removing excess amounts of the first solvent for re-use in the soaking step; and
removing a residual amount of the first solvent from the pressed PET textile to produce the substantially pure PET textile.

45. The system of claim 44, wherein the removing excess amounts of the first solvent comprises mechanically pressing the solvent-wet PET textile to collect a bulk of the first solvent from the solvent-wet PET textile.

46. The system of claim 44, wherein the removing a residual amount of the first solvent includes washing the pressed PET textile with a second solvent having a boiling point lower than the first solvent and drying the washed PET textile.

47. The system of claim 46, wherein the second solvent is selected from acetone, ethanol, and methanol.

48. The system of claim 44, wherein the removing a residual amount of the first solvent includes evaporating the residual amount from the pressed PET textile and recycling the evaporated first solvent to the soaking step of the continuous solvent extraction process.

49. The system of any of claims 44-48, wherein said soaking the input with the first solvent comprises conveying the input on a permeable screen through a series of varying velocity solvent streams, each subsequent solvent stream in the series having a flow rate greater than a preceding solvent stream in the series.

50. The system of claim 49, further comprising reusing solvent recovered from a subsequent one of the series of solvent streams in a preceding one of the series of solvent streams.

51. The system of any of claim 41, wherein the first processing path further includes one or more PET processing modules connected downstream of the polyester separation module and configured to produce new polyester fibers from the substantially pure PET fabric output by the polyester separation module.

52. The system of claim 51, wherein the one or more PET processing modules are configured to densify the substantially pure PET fabric and produce densified PET material, heat the densified PET material to produce a PET melt, and spin a new PET fiber from the PET melt.

53. The system of claim 52, wherein the one or more PET processing modules are configured to heat the densified PET material under vacuum to produce a PET melt with increased intrinsic viscosity (IV).

54. The system of claim 51, wherein the one or more PET processing modules include:
a shredder that receives the substantially pure PET fabric;
a press operatively coupled to the shredder to compact the output of the shredder for outputting the densified PET material;
a heated screw extruder that receives the densified PET material; and
a vacuum mixing chamber operatively associated with the heated screw extruder for heating the densified PET material under vacuum.

55. The system of claim 36, wherein the second processing path comprises one or more cellulose processing modules configured to produce man made cellulose fiber (MMCF) from cellulose-based materials received from the sorting module and/or the first processing path.

56. The system of claim 55, wherein the first output stream of shredded textile waste substantially excludes polycotton blends of textiles, the sorting module configured to output the polycotton blends of textiles as a third output stream of shredded textile waste to a polycotton processing module configured to separate cellulose from the polycotton blends using a solvent different from the first solvent.

57. The system of claim 56, wherein the polycotton processing module outputs the cellulose separated from the polycotton blends as cellulose pulp or powder to the cellulose processing module associated with the second processing path.

58. The system of claim 56, wherein the polycotton processing module is configured to:
dissolve the cellulose by applying a cellulose solvent to the polycotton blends thereby forming a cellulose-and-solvent solution; and
regenerate and separate the cellulose from the cellulose-and-solvent solution thereby separating the cellulose, as a regenerated cellulose fiber, film, pulp or powder, from the third output stream of shredded textile waste.

59. The system of claim 58, wherein the cellulose solvent is selected from the group consisting of an aqueous electrolyte solution, an organic electrolyte solution, and an ionic liquid.

60. The system of claim 56, wherein the polycotton processing module is configured to separate the cellulose from PET in the polycotton blend by at least a partial glycolysis of the PET.

61. The system of claim 56, wherein the polycotton processing module is configured to separate the cellulose from PET in the polycotton blend by density.

62. The system of any of claim 56, wherein the polycotton processing module further outputs PET melt to the one or more PET processing modules with the first processing path.

63. A system for recycling textile waste, the system comprising:
a sorting assembly configured to receive an input stream of mixed textile waste including blends of a primary textile material with one or more impurities and non-textile components, wherein the sorting module is configured to shred the mixed textile waste to produce shredded textile waste, and to autonomously separate substantially all of the non-textile components from the shredded textile waste to produce an output stream of sorted textile waste containing substantially only the blends of the primary textile material with the one or more impurities; and
a processing assembly comprising a conveyor system that supplies the sorted textile waste to at least one chemical processing unit configured to remove substantially all of the one or more impurities, outputting substantially only the primary textile material for use in producing recycled textile fibers, wherein the processing assembly includes:
a conveyor belt configured to support the sorted textile waste while being conveyed along a travel path;
a series of nozzle assemblies spaced apart lengthwise along the travel path to define a plurality of solvent application stages, each nozzle assembly configured to dispense a stream of solvent toward the textile waste on the screen, and wherein the nozzle assembly associated with a subsequent solvent application stage dispenses solvent at a greater flow rate than the nozzle assembly associated with a preceding solvent application stage; and
a solvent recycling circuit configured to collect dispensed solvent from one or more of the solvent application stages and provide the collected dispensed solvent from at least one of the subsequent solvent application stages to the nozzle assembly of at least one preceding solvent application stage.

64. The system of any of claim 63, wherein the conveyor belt includes a screen that supports the sorted textile waste while being conveyed along a travel path and wherein the solvent recycling circuit includes a plurality of fluidly de-coupled collection units located below the screen at each of the solvent application stages, and wherein the collection unit associated with a given solvent application stage is fluidly coupled only to the immediately preceding solvent application stage.

65. The system of any of claim 63, wherein the solvent recycling circuit is further configured to purify the collected dispensed solvent from the first solvent application stage of the series and couple the purified solvent to the nozzle assembly of the last solvent application stage of the series.

66. A method of recycling textile waste, the method comprising:
receiving, in a recycling system, a single input stream of mixed composition textile waste, wherein the mixed composition textile waste includes at least one blend of a primary textile material with one or more impurities and non-textile components;
shredding the mixed composition textile waste to produce a stream of shredded textile waste;
autonomously separating the non-textile components from the shredded textile waste to produce an output stream containing substantially only textile material and impurities;
conveying the output stream along a travel path of the recycling system and through a textile purification process, wherein the textile purification process includes:
applying a first type of solvent, in a plurality of solvent application stages arranged in series along the travel path, to soak the textile material in the output stream with the solvent;
collecting used solvent from one or more subsequent solvent application stages and re-using the collected used solvent in one or more preceding solvent application stages;
purifying the used solvent collected from a first stage of the plurality of solvent application stages; and
re-using the purified solvent in a last one of the plurality of solvent application stages to form a closed solvent loop for the first type of solvent in the recycling system.

67. The method of claim 66, wherein the primary textile material in the mixed composition textile waste is polyester, and wherein the first type of solvent is a solvent incapable of decomposing the polyester.

68. The method of claim 67, wherein the first type of solvent is selected from the group consisting of aprotic solvents, bio-based alkyl esters, cyclic ketones having a general structure (CH₂)ₙCO, wherein n is equal to 4, 5, 6 or 7, diacetone dialcohol, and tetrahydrofurfural alcohol.

69. The method of any of claims 66-68, wherein the mixed composition textile waste includes one or more blends of at least two different types of textile materials, and wherein the method further comprises autonomously sorting the blends of the different types of textile materials into different output streams.

70. The method of claim 69, wherein one of the different output streams is processed via the textile purification process and another one of the different output streams is diverting for processing via a different chemical process than that of the textile purification process.
